(19) United States
(12) Patent Application Publication
(10) Pub. No.: US 2015/0325141 A1
(43) Pub. Date: Nov. 12, 2015

(54) Touch-centric Learning and Research System

(71) Applicant: Wallace Saunders, Forest, VA (US)

(72) Inventor: Wallace Saunders, Forest, VA (US)

(21) Appl. No.: 14/709,399

(22) Filed: May 11, 2015

Related U.S. Application Data
(60) Provisional application No. 61/991,183, filed on May 9, 2014.

(51) Int. Cl. G09B 19/00; G09B 5/06

(52) U.S. Cl. CPC G09B 19/00; G09B 5/06

(57) ABSTRACT

A touch-centric learning system directed to use of a singular system without the need to access external Internet searches to support matriculation at multiple degree levels within one or more fields of education wherein all resources required for moving toward successful completion of required course work are accessed via a touch interface. The system further including a plurality of resource repositories structured and assembled to automatically provide expedited and intelligent access to and between the various resources in each of the repositories.

### CROSS-REFERENCE TO RELATED APPLICATIONS

This application claims the benefit of U.S. Provisional Application No. 61/991,183, filed May 9, 2014.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND

1. Field of the Invention

The invention relates generally to educational and research systems. More particularly, the invention relates to such a system targeted to matriculation in the field of business for use on tablets and other touch-centric devices.

2. Related Art

There exist a plethora of web-based systems designed to support learning and education in various subject matters. The web-based systems are generally directed to providing a platform for course content and grading similar to a standard classroom approach rather than a process for readily accessing and associating relevant knowledge associated with a particular overall curriculum of learning. Existing systems may provide access to subject matter content in specific fields of study targeted toward certain educational levels. Existing web-based systems are designed primarily for academia; they are not designed to support the knowledge gathering needs of industry users in tandem.

Existing systems are designed to be operated via mouse and keyboard and do not readily support interaction via touch in a streamlined and efficient manner. Additionally, existing systems require significant manual interaction rather than providing automated and intelligent selection of various knowledge elements while in use. Still further, to the best of applicant's knowledge, none of the existing systems provide a method by which curriculum and course content can be readily shared across multiple levels of higher education matriculation, e.g., a bachelor's degree, a master's degree and a doctorate.

Consequently, there exists a substantial unmet need for a digital, interactive learning system that is optimized via use on a tablet or other touch interface that can serve hybrid needs between academia and industry in an intelligent, streamlined and comprehensive manner. Further, there exists a need for such a system capable of aggregating multiple levels of curriculum and content for continuous matriculation in a selected field of education.

### BRIEF SUMMARY OF THE INVENTION

In view of the foregoing described needs, an embodiment of the present invention includes a touch-centric learning system capable of simultaneously supporting the needs of academia and industry. The system comprises a computing device having a touch-centric interface such as a tablet, a mobile phone or desktop touch screen. The system aggregates resources, knowledge, research and content in an intelligent manner and links various aspects of these resources and content in a manner that is easily accessed via touch without reliance on a keyboard or mouse. Resources and content can be widely distributed across various data centers and other digital resources, or, customized content may be collected and made available through local optimized servers.

In an exemplary embodiment, the system discloses an interface directed to education and knowledge gathering for financial, economic and business matters. More specifically, the system supports the deployment of one or more syllabi associated with academic instruction and education, concurrent with intelligent association of resources for both academic use and industrial use. Consequently, the exemplary embodiment serves dual use as both an instrument for academic instruction and learning as well as a tool for industrial research and investigation. As configured, the system supports matriculation across several advanced education levels while leveraging a common interface and structure. One skilled in the art would recognize that although described herein as supporting business matriculation and research, the system is adaptable to support any syllabi or curriculum for any field of knowledge.

Structurally, the system comprises a plurality of mini-apps, hereinafter referred to as “modules”, having specific associated content wherein each of the modules intelligently connects with content in one or more of the other modules. User selection of a particular module and selection of content within the module causes the system to trigger expectations within other modules for provision of other relevant content to the user. In a first embodiment, the modules provide functionality to support:
a) identification of a particular course/subject matter syllabus,
b) selection of a particular industry of interest,
c) access to audio discussions from selected experts on a selected topic,
d) access to a plurality of relevant resources that complement course requirements or support corporate inquiry,
e) cross-referencing selected content to other countries and regions,
f) cross-referencing to various other web-based resources relevant to course topics or on-point with the relevant corporate inquiry and decision-making requirements, g) access to relevant business cases driven by earlier selections which are deemed supportive of the academic and industrial inquiries, and,
h) provision of immediate access to e-Books consistent with or complementary to the course of study or evolving shape of the industrial inquiry.

### BRIEF DESCRIPTION OF THE DRAWINGS

For a more complete understanding of the present invention, reference is made to the detailed description contained herein and the accompanying drawings numbered below which are given by way of illustration only and are not intended to be limitative to any extent. Commonly used reference numbers identify the same or equivalent parts of the claimed invention throughout the several figures. Now, therefore:

FIG. 1 is an illustration of exemplary matriculation levels supported by the system touch-centric interface;

FIG. 2 is an illustration of exemplary content categories supported by the system;

FIGS. 3A and 3B illustrate a structural diagram of an exemplary compute and network architecture associated with the system, according to the invention;

FIG. 4 is a diagram of an exemplary embodiment of functionality associated with a typical module;

FIGS. 5A and 5B are more detailed diagrams of functionality associated with a particular module;

FIG. 6A is a diagram of structural content associated with a sample syllabus;

FIG. 6B is an exemplary screenshot of a sample syllabus for a particular field of study presented to a user;

FIG. 7 is a screen shot of an embodiment of the system interface allowing a user to select from a plurality of different industries;

FIG. 8 is a diagram of the structure of the functionality associated with access by a user to audio and/or video resources for various subject matter experts;

FIG. 9 is a screen shot of an embodiment of the system interface providing access to subject matter experts;

FIG. 10 is an illustration of an embodiment of the system supporting translation of an audio lecture into the English or other native language of a user;

FIG. 11 is an illustration of the functionality for selection of resources to complement course requirements or specific corporate inquiry;

FIGS. 12A-12D are exemplary screen shots of an embodiment of the system interface allowing a user to select from a plurality of resources;

FIG. 13 is a diagram of the structure of the functionality associated with the system;

FIG. 14 is an illustration of the functionality of the system associated with cross-referencing to selected country-regions;

FIG. 15 is an exemplary screen shot of an embodiment of the system interface allowing a user to select from a plurality of resources associated with cross-referencing to country-regions;

FIG. 16 is one illustration of potential content displayed to a user when targeting country-region cross references;

FIG. 17 is a diagram of the structure of the functionality associated the system providing additional cross reference to Internet accessible resources;

FIG. 18A-N are exemplary screen shots of an embodiment of the system interface allowing a user to select from a plurality of Internet-accessible resources intelligently cross-referenced to a selected inquiry;

FIG. 19 is a diagram of the structure of the functionality of the system providing access to relevant business cases:

FIG. 20 is an exemplary screenshot of the system interface for access to case methods;

FIG. 21 is a diagram of the structure of the functionality of the system providing access to relevant literature;

FIG. 22 is an exemplary screenshot of the functionality of the system illustrated in FIG. 21; and

FIG. 23 is an illustration of access to electronic literature resources provided by the system.

### DETAILED DESCRIPTION

The following description is merely exemplary in nature and is in no way intended to limit the invention, its application, or its uses. Objects, features, advantages, and aspects of the present invention will be set forth in part in the description that follows, and in part will be obvious from the description or may be learned by practice of the invention. In the description, reference is made to the accompanying drawings, which form a part thereof, and in which is shown by way of illustration a specific embodiment for practicing the invention. This embodiment will be described in sufficient detail to enable those skilled in the art to practice the invention, and it is to be understood that other embodiments may be utilized and that structural changes may be made without departing from the scope of the invention. Following is a description of an exemplary embodiment of a touch-centric learning and knowledge gathering system 10 according to the invention.

In an exemplary embodiment, the system 10 provides touch-centric access to all resources required to support curricular-based applications that are sufficiently integrated to provide a holistic course of study for successful completion of each individual degree level associated with an academic field of study while using the same system 10 throughout the matriculation period. This same system 10 supports industrial inquiry simultaneously.

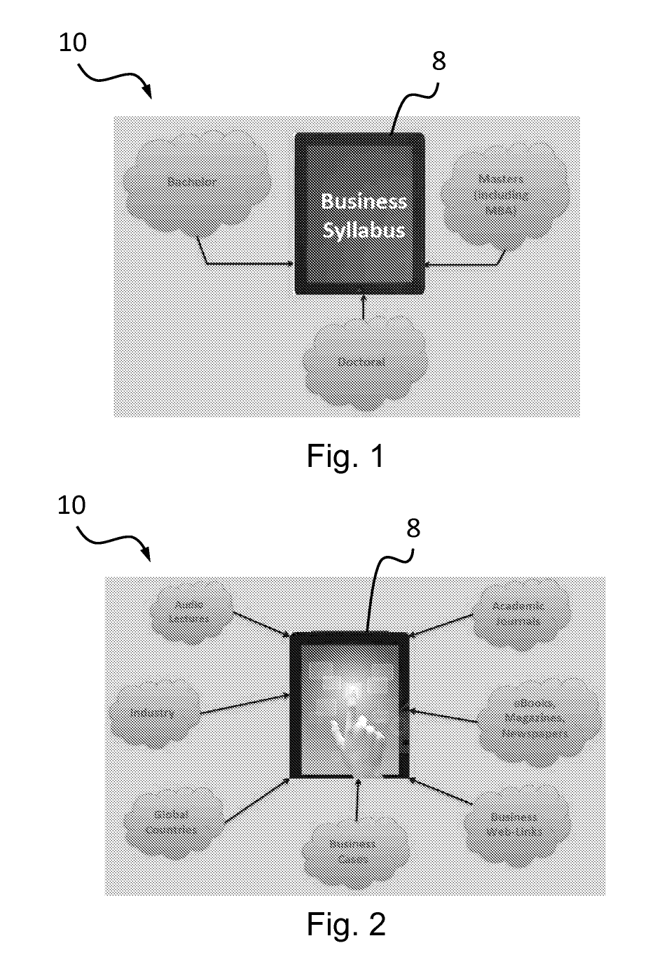

As shown in FIG. 1, a user will interface with the system 10 relying on the touch-centric features of a touch-centric device 8, such as a tablet or desktop computer having a touchscreen interface. For simplicity, although the invention is applicable to both existing and future touch-centric devices, we will refer herein to a “tablet” or “touch-centric device” as representative of all touch-centric devices. By interacting with the tablet, a user will be presented with a first displayed page which allows the user to initially choose and then access a specific business syllabus that is geared to support the present level of educational matriculation. As configured, the system 10 provides software and other digital resources to support additional subsequent levels of matriculation within one or more fields of study. These matriculation levels include, but need not be limited to, completion of degrees in business at the bachelor, masters, doctoral and post-doctoral levels. The system 10 allows access to relevant software programs to be run directly on each tablet 8 for local access, and, supplemented with online access via additional web-based services.

Referring now to FIG. 2, the system 10 supports a touch-centric structure that provides an integrated set of software applications, referred to herein as “modules,” 100 to address requirements and resources for successful completion of multiple degree levels in a field of study. Each touch-centric device 8 serves as a portal for access to a plurality of integrated resources, including academic journals, eBooks, magazines, newspapers, business web-links, business cases, global countries, industry resources, and related audio lectures.

The system 10 provides an optimized experience for delivery of appropriate curricula and educational and research resources to a plethora of different industry stakeholders including, but not limited to:
a) CXOs, including executives, operating, financial and technology officers
b) general managers,
c) directors of marketing, accounting, human resources, information technology,
d) managers of production, operations, quality control, environmental and business development.

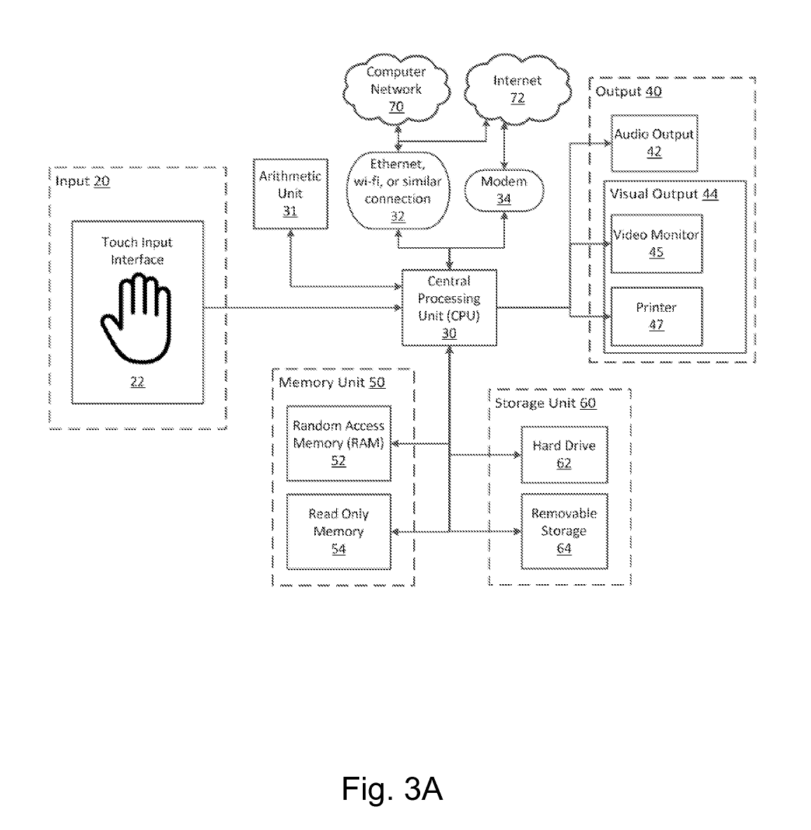

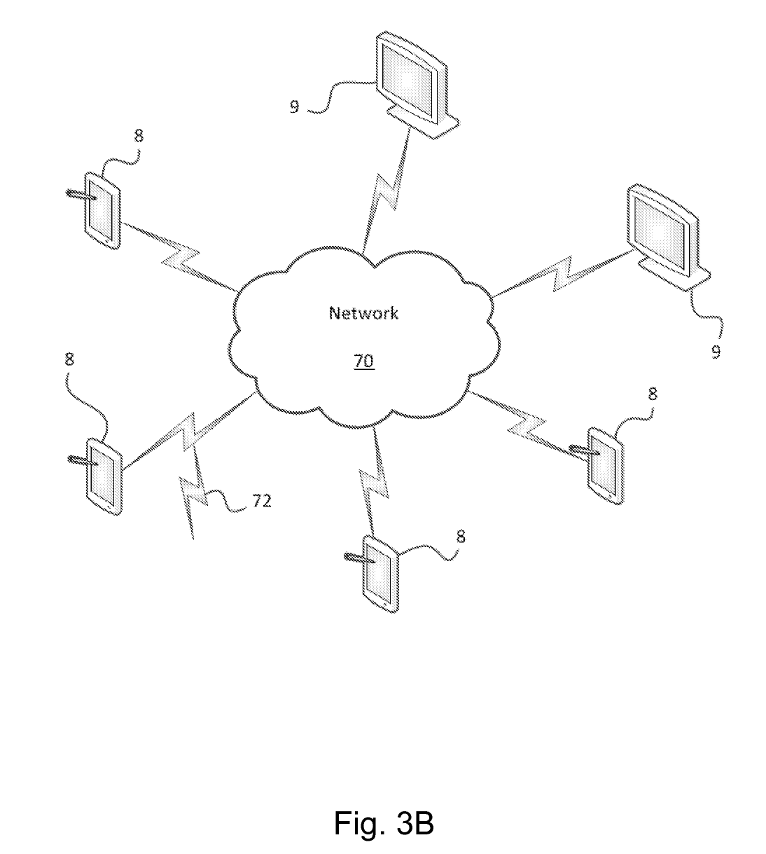

Referring to FIG. 3A, a schematic of the architecture of a touch-centric computing device 8 used as a core element of the system 10 is described. The touch-centric computing device 8 may be any of a tablet, mobile phone or touch-centric desktop computer 9 with a touchscreen interface. For simplicity, we hereinafter refer to the touch-centric device 8 as a tablet 8. There are several forms of tablets available for adaption to the system 10 including Apple's iPad, Microsoft's Surface and others.

Although today's tablets may include multiple forms of input 20, the system 10 of the present invention relies only on touch input 22 for interaction by a user. Output 40 modes include audio output 42 and visual output 44, which may include output to both a video monitor 45 and a printer 47 to print content as desired by a user. The tablet 8 includes a central processing unit (CPU) 30 with an arithmetic unit 31 for processing instructions associated with the software of the system 10. The tablet also includes a memory unit 50 comprised of random access memory (RAM) 52 and read only memory (ROM) 54. The system 10 has flexibility and scalability since data storage is provided by a storage unit 60, which may be any of a hard drive 62 or removable storage 64. A hard drive 62 used for storage may be local or remote, on a cloud or network-attached storage device. Each of the data storage units 60 serve as digital repositories for one or more resources of information. The tablet 8 includes a communication modem 34 for network access via, for example, either Ethernet or Wi -Fi 32. The tablet 8 communicates with a computer network 70 and the Internet 72.

The touch interface 22 associated with the system 10 allows input by either a person's fingers or a stylus. Thus configured, commands may be given to the system 10 by simply using one's fingers or, if desired, a separate stylus, or both. Additionally, notes or annotations may be added to the system 10 or content using fingers or a stylus adapted for hand-written input into the system. Although this configuration may appear too restrictive as compared to systems that accommodate input via a microphone, a mouse a keyboard or other similar input device, the present invention is intentionally restricted to the touch input functionality of devices. The purpose of this restriction is intended to ensure that a user relies solely on touch-centric input interface 22 and therefore learns to optimally use the system 10 which has been designed to optimally leverage the capability of touch. Typically, the ultimate benefits of touch are not achieved since more than a single mode of input is provided to a user. The present invention eschews the use of a mouse and separate keyboard. The present invention is targeted toward and relies solely on the input mode of touch.

Referring to FIG. 3B, an exemplary illustration of network interactivity for one or more tablets 8 or touch-centric computers 9 is illustrated. The system 10 is configured to support one or more users simultaneously when resources, content and other data are provided via other Internet resources. FIG. 3B is a simplified view of the networked implementation of the system 10 according to the invention. One or more tablets 8 and one or more touch-centric computers 9 are connected to a computer network 70. The computer network 70 may provide controlled local access or provide broader access 72 to the Internet, a cloud-based network, a private network or another network. The system 10 according to the invention supports a local network structure as long as the system 10 is configured to ensure that all relevant content is downloaded to a repository for access on the local area network. Where local access is not required, the system 10 can rely on access via standard Internet links.

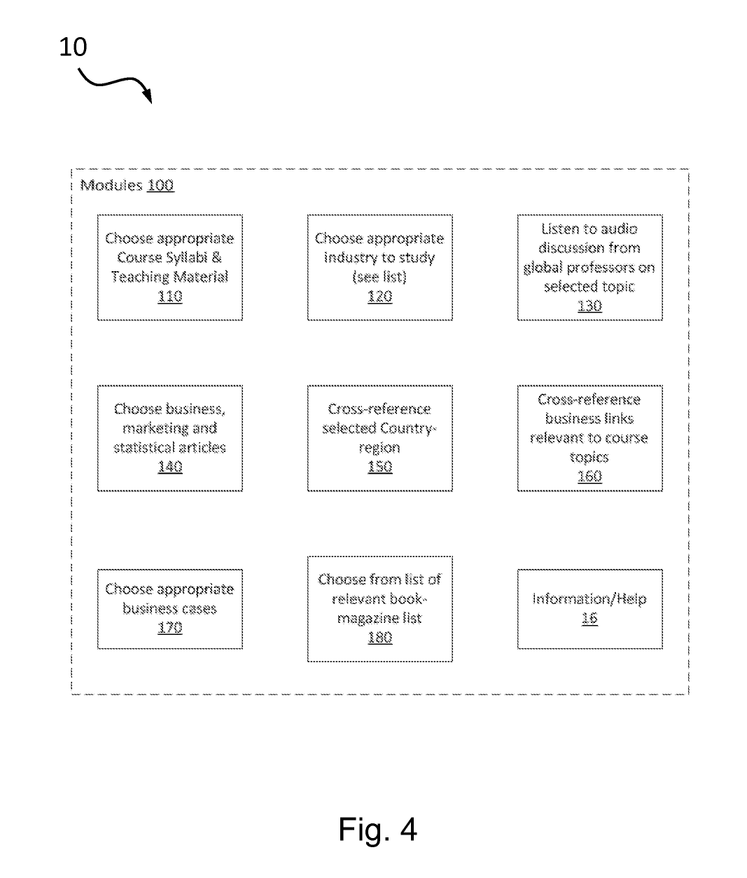

Referring to FIG. 4, an exemplary chart showing the structure of the system 10 as applicable to software modules 100 is illustrated. The system 10 comprises a software module schema composed of a plurality of modules 100 wherein each module 100 is intelligently connected with content or metadata in one or more of the other modules 100. Selection of a particular module 100 and selection of content within the module 100 triggers expectations within one or more of the other modules 100 for provision of additional relevant content to a user.

The schema of a plurality of interconnected modules 100 collaborate as part of the larger program to be executed on the tablet 8. Each of the modules 100 function independently of one another, but also function as a holistic integrative program application on the tablet 8. Each of the modules 100 contains both depth and breadth in accessibility and content for both learning audiences, academic and industry. Each of the independent modules 100 is executed by activities/tasks driven by the structure of the syllabus selected by a user at the outset. Having a complete resource readily available, the industry manager, who perhaps never obtained an MBA, will have access to the same information as the very MBAs he/she hires. Each of the independent modules 100 are interrelated to condition the learner, whether student or industrial, to adopt a “Global Mind-Set.” The modules 100, their function, and instructions for access and use on a particular user interface as part of a program application is explained to the user by accessing an information/help feature 16.

In one version, the modules 100 provide functionality for a user to, among other capabilities:
a) via module 110, choose an appropriate course syllabi and teaching material,
b) via module 120, select a particular industry of interest,
c) via module 130, access audio discussions from selected experts across the globe on a selected topic,
d) via module 140, access a plurality of relevant resources including business, marketing and statistical articles that complement course requirements or support the targeted corporate inquiry,
e) via module 150, cross-reference selected content to other countries and regions,
f) via module 160, cross-reference to various other web-based resources relevant to course topics or on-point with the relevant corporate inquiry and decision-making requirements,
g) via module 170, access and select relevant business cases deemed supportive of the academic and industrial inquiries, and
h) via module 180, obtain immediate access to relevant e-Books, magazines and newspapers consistent with or complementary to the course of study or evolving shape of the industrial inquiry.

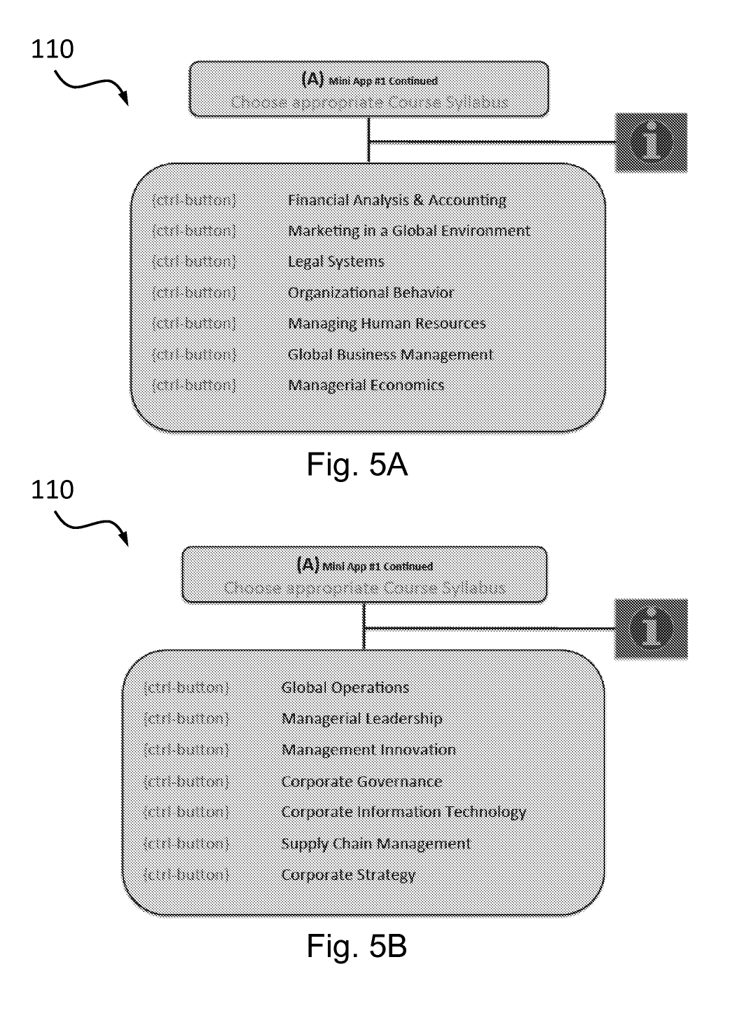

Referring to FIGS. 5A and 5B, an exemplary illustration of the structure for selection of course syllabi enabled by the syllabus selection module 110 is shown. A user of the syllabus selection module 110 is provided a choice between a plurality of different course syllabi, for example, financial analysis and accounting, marketing in a global environment, legal systems, organizational behavior, human resources, global business management and managerial economics, et al. Once the user has selected a desired course syllabus via syllabus selection module 110, the user will then have access to the various available activities and resources associated with the selected course syllabus. These include activities such as choosing an industry, listening to audio discussions, choosing academic articles, cross-referencing to other country-regions, cross-references to other web resources, choosing business cases, and, choosing relevant books and magazines.

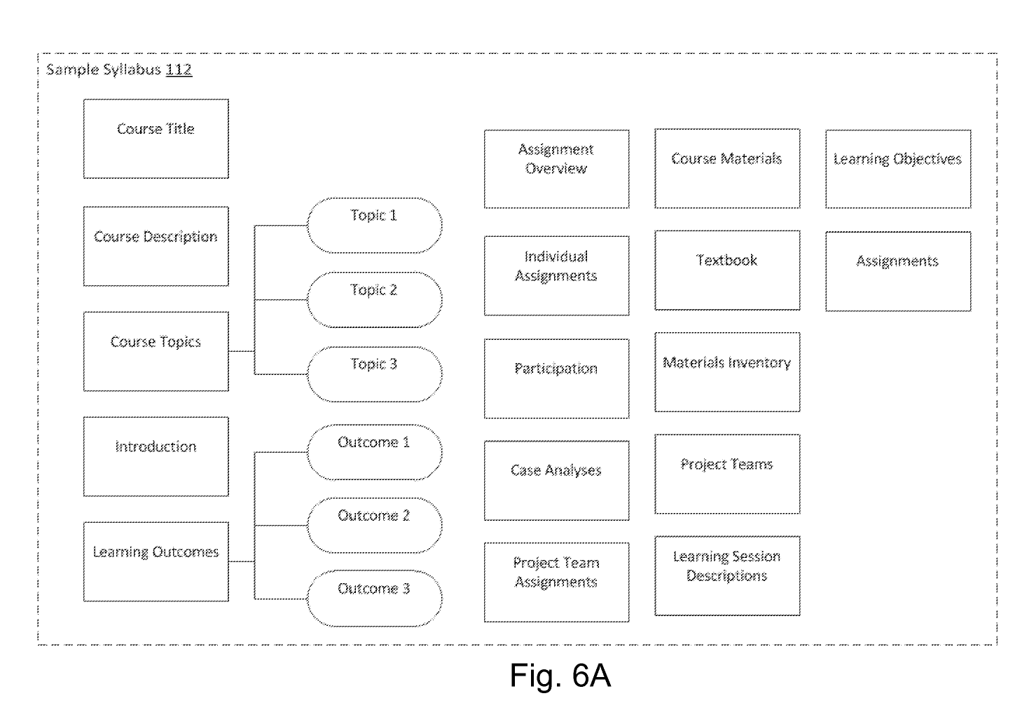

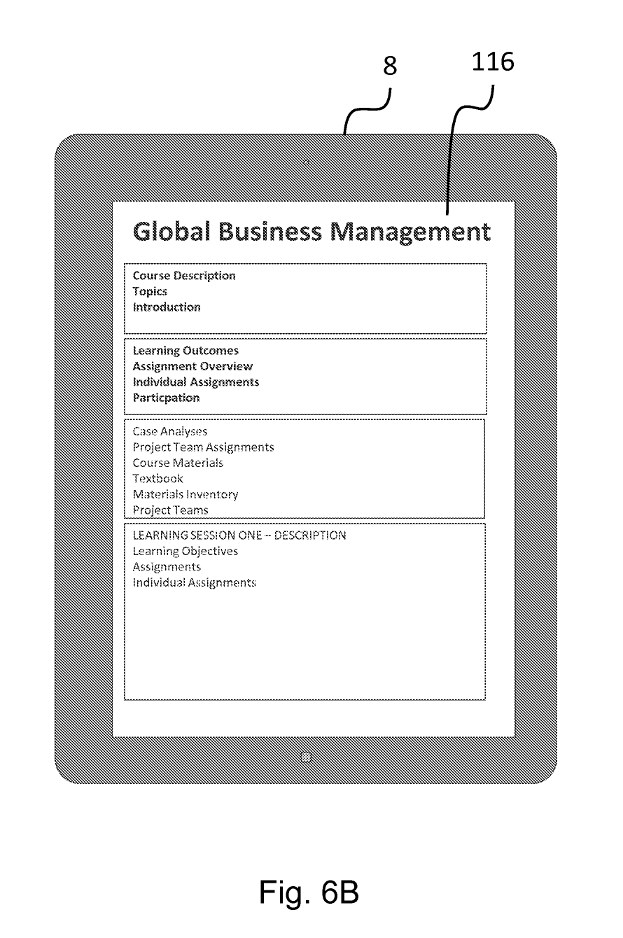

Referring to FIG. 6A, the structure for a sample course syllabus 112 enabled by the syllabus selection module 110 is presented. The system 10 first presents a user with several relevant pieces of information associated with the selected course of study. As shown, the syllabus structure 112 includes a course title, a detailed course description, topics covered, an introduction associated with a planned agenda, and a discussion of expected learning outcomes for a student. Further detail provided will include an overview of assignments along with a description of individual assignments, participation information, case analyses, and team project assignments. Relevant course materials are also described including required textbooks or eBooks, materials inventory, and project team lists along with learning session descriptions. The syllabus structure 112 will also provide information to the user concerning learning objectives and the related assignments.

FIG. 6B is an exemplary syllabus output screenshot 116 on a tablet 8 illustrating major elements of a sample course syllabus presented to a user. Once the user has selected a desired syllabus, the user is provided with a description of a first learning session as shown in screenshot 116. This description defines the learning objectives and the assignments, along with a list of activities associated with the learning session.

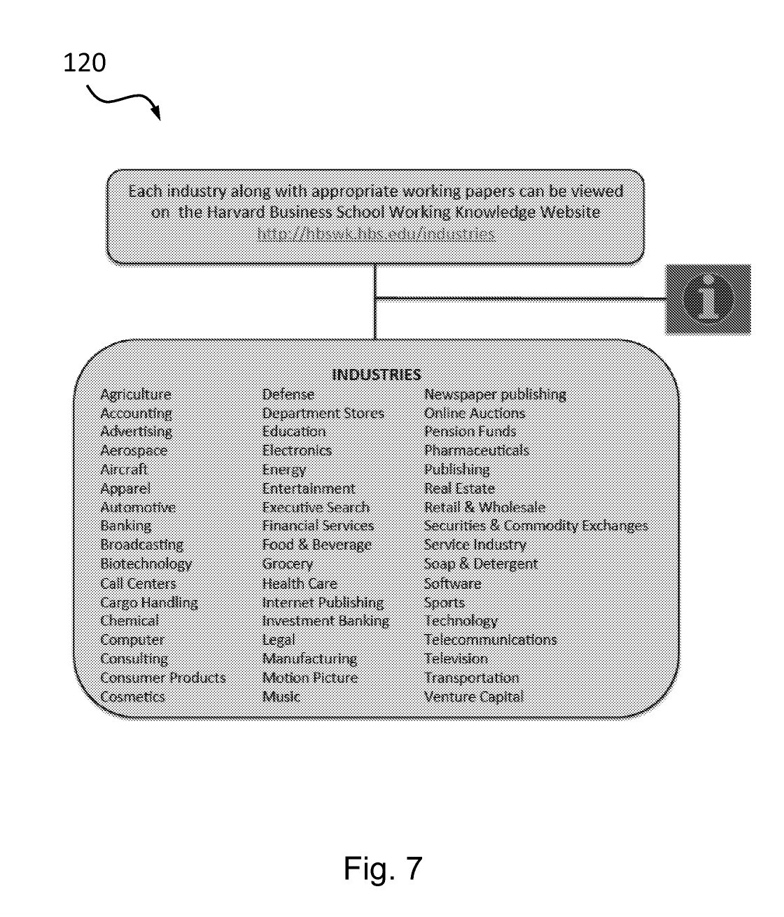

Referring now to FIG. 7, industry selection module 120 causes the system 10 to present an exemplary list of relevant industries from which a user may select for further education and inquiry. The list of industries provided are naturally associated with the selected curriculum of study, e.g., business and the particular selected syllabus. For example, in the event the system 10 is adapted to the study of engineering or medicine, rather than business, the list of industries may change somewhat to reflect those most relevant to the engineering or medical field of study. Once the user selects a specific industry, the system 10 causes information and resources associated with the selected industry to be prioritized for presentation to the user in keeping with the syllabus structure 112.

Industry selection module 120 allows the user to choose an appropriate industry to study. A particular industry will be chosen for study or research from the list provided. As a course of academic study, usually a specific industry will be used in a case study. Post-graduate knowledge can also be obtained via this portal to complement a management-level position working in a variety of industries.

In one version of the system, each industry along with appropriate working papers can be viewed on the Harvard Business School Working Knowledge Website http://hbswk.hbs.edu/industries. As shown below in Table 1, in one version of the system 10, industries include:

TABLE 1

| | | |
|---|---|---|
| Agriculture | Accounting | Advertising |
| Aerospace | Aircraft Apparel | Automotive |
| Banking Broadcasting | Biotechnology Call | Cargo Handling |
| | Centers | |
| Chemical | Computer | Consulting |
| Consumer Products | Cosmetics | Defense |
| Newspaper publishing | Department Stores | Education |
| Electronics | Energy | Entertainment |
| Executive Search | Financial Services | Food & Beverage |
| Grocery | Health Care | Internet Publishing |
| Investment Banking | Legal | Manufacturing |
| Motion Picture | Music | Newspaper Publishing |
| Online Auctions | Pension Funds | Pharmaceuticals |
| Publishing | Real Estate | Retail & Wholesale |
| Securities/Commodity | Service Industry | Soap & Detergent |
| Exchanges | | |
| Software | Sports | Technology |
| Telecommunications | Television | Transportation |
| Venture Capital | | |

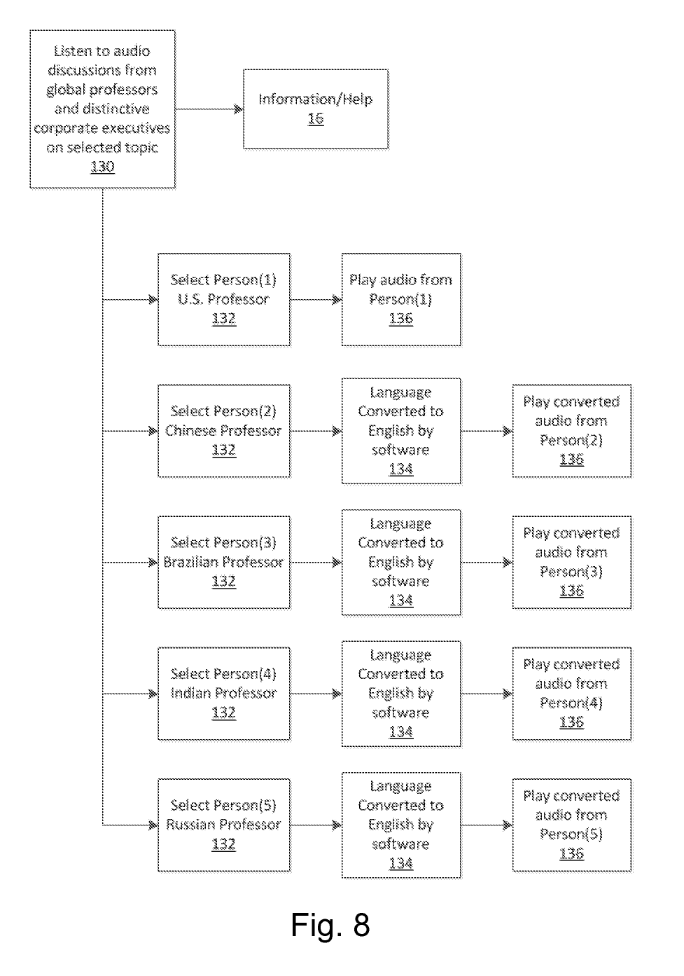

Referring now to FIG. 8, audio module 130 allows one or more users to concurrently access relevant audio discussions from one or more professors and corporate executives across the globe. A user is presented with discussions and presentations from various notables relevant to a selected topic. The user may select a professor 132 or other representation to access a desired discussion, whereupon the audio is played to the user 136. Where the audio is not in the native language of a user, in an exemplary case, English, the audio is converted to the English language by audio module 130 in a translation function 134 and then played to the user 136. The system 10 provides translation of each of the audio discussions from around the world to the language of the student or industrial researcher. The translation may be presented in either an audio format or in visual subtext.

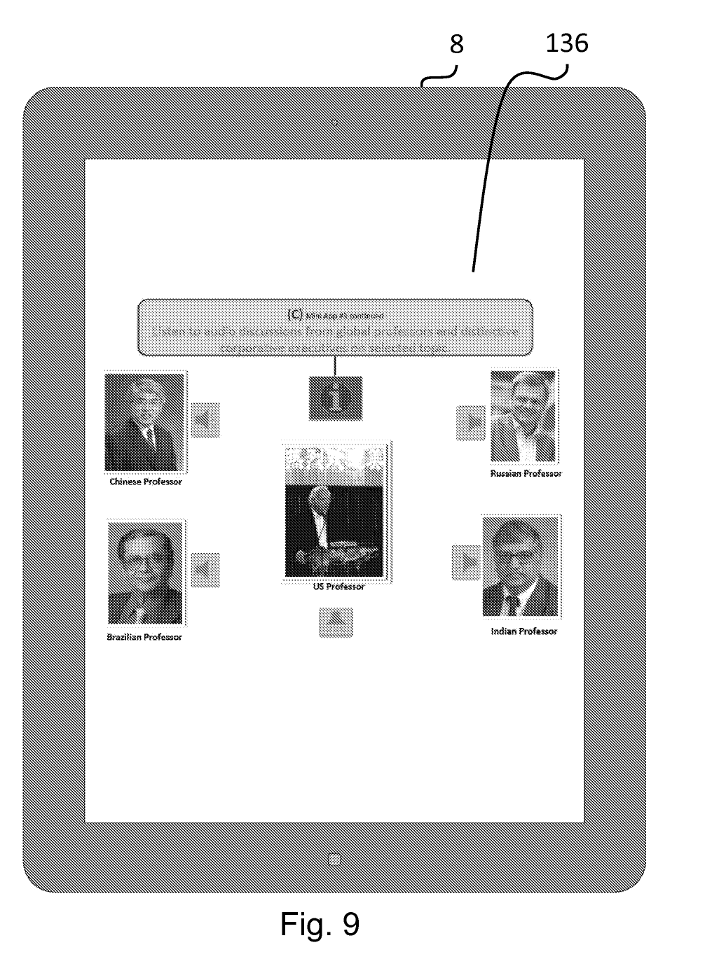

FIG. 9 is an exemplary audio selection screen shot 136 on a tablet 8 associated with audio module 130 presented to a user of the system 10 and associated with access to audio discussions from various experts in different countries and possibly in different languages. To hear any of the presentations or discussions from any other persons listed on the screen, the user needs only to touch the speaker icon adjacent an image of the speaker to initiate the audio delivery.

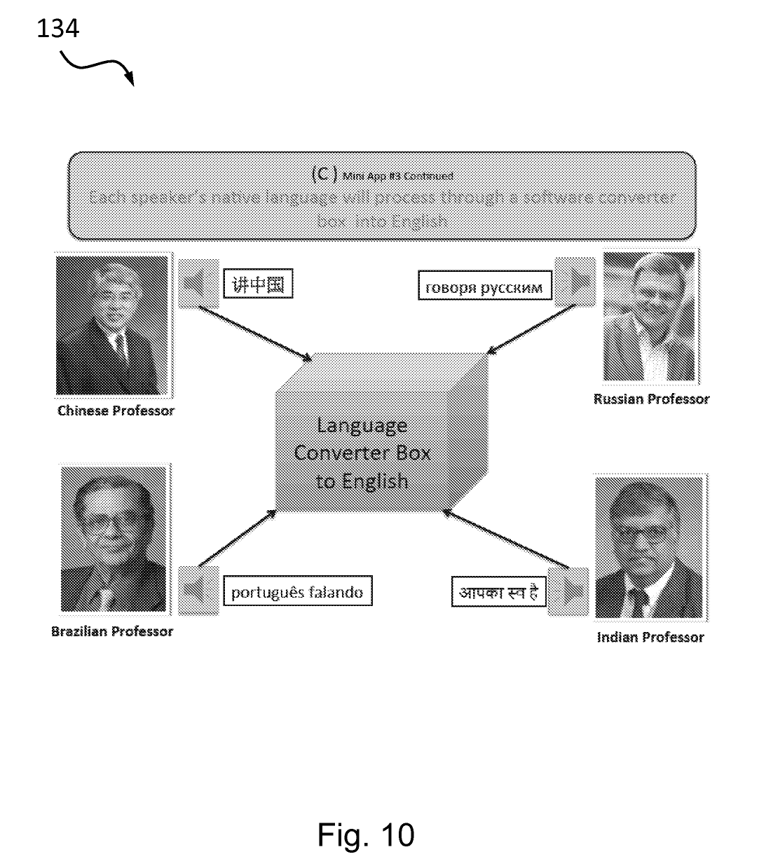

FIG. 10 is an illustration of the translation function 134 of the audio module 130 which allows a user to listen in their native language—in this case, English. The illustration shows discussions in Chinese, Russian, Portuguese and Indian languages being converted to English. Although shown as providing translation into English, the audio module is capable of converting the audio into multiple languages to accommodate a range of international users.

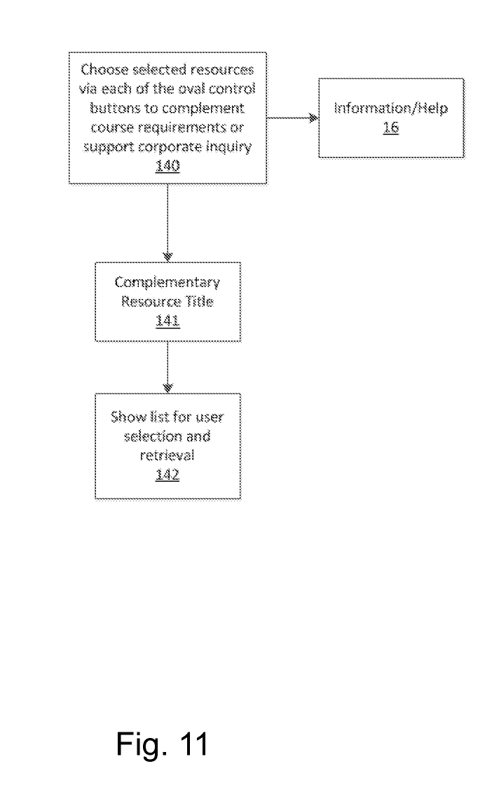

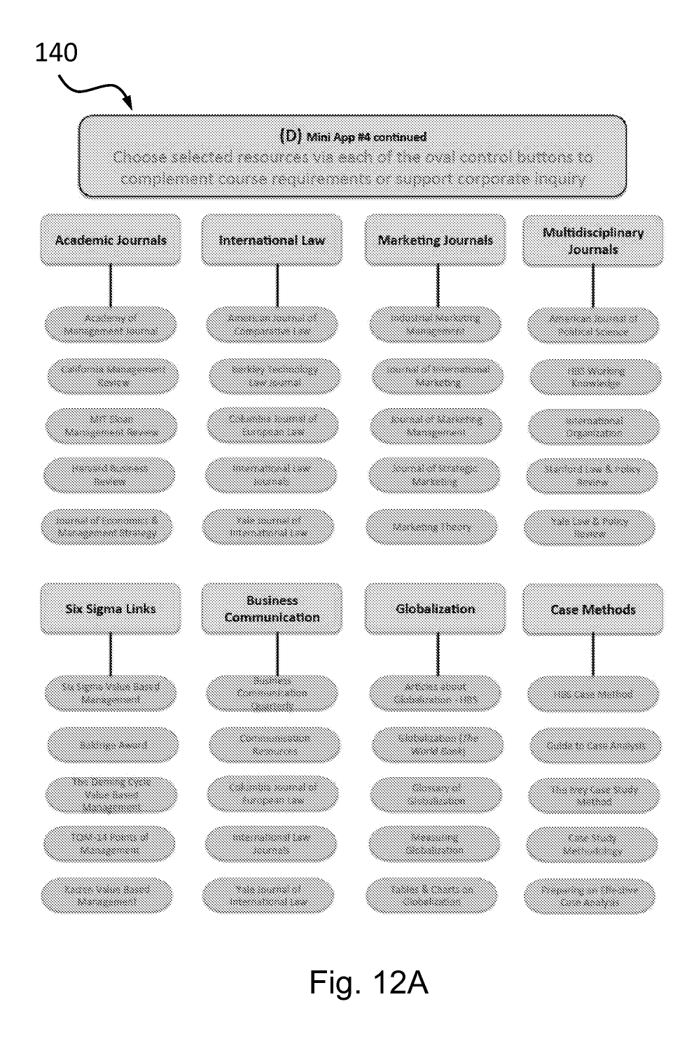

Referring now to FIG. 11, a content selection module 140 provides structure and functionality to support the delivery of a plurality of resources 141 from which a user can choose to complement course requirements or support the specific corporate inquiry. Again, the content selection module is intelligently driven by the syllabus selection and other selections and triggers associated with the use of other modules 100. When the content selection module 140 is activated by the user, a list of relevant resources is shown to the user for selection and retrieval 142. Relevant resources can include business, marketing and statistical articles, among others, which have been deemed relevant to the particular course of study. In addition, relevant resources include access via email, telephone, real-time text chat, or video conference to a professor, instructor, or subject matter expert.

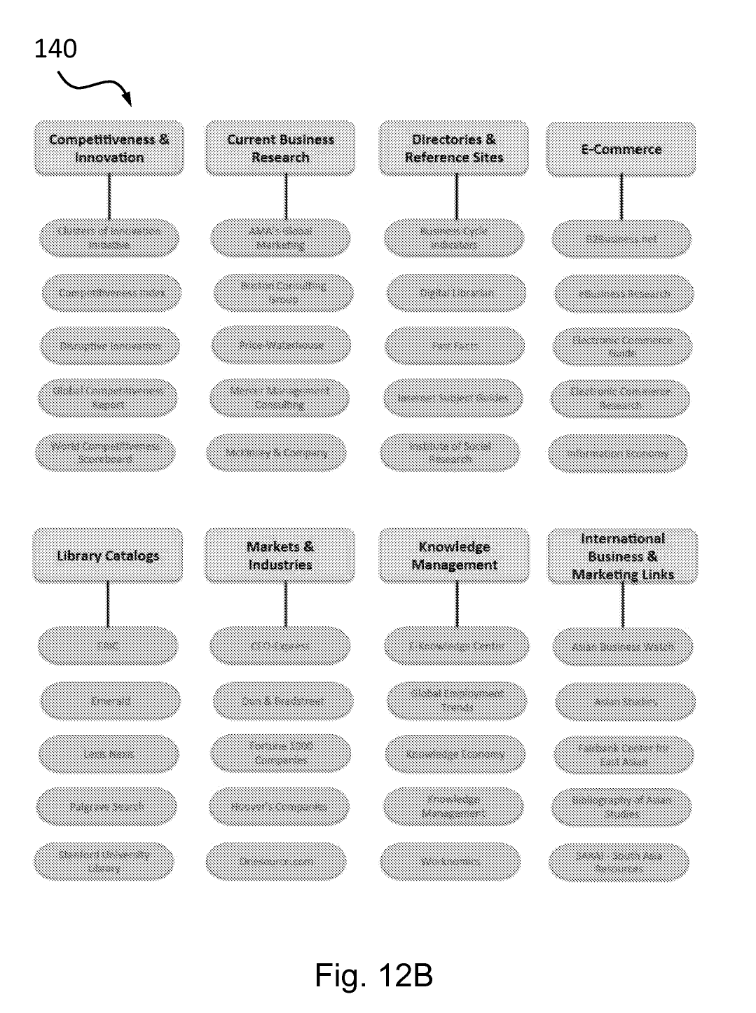

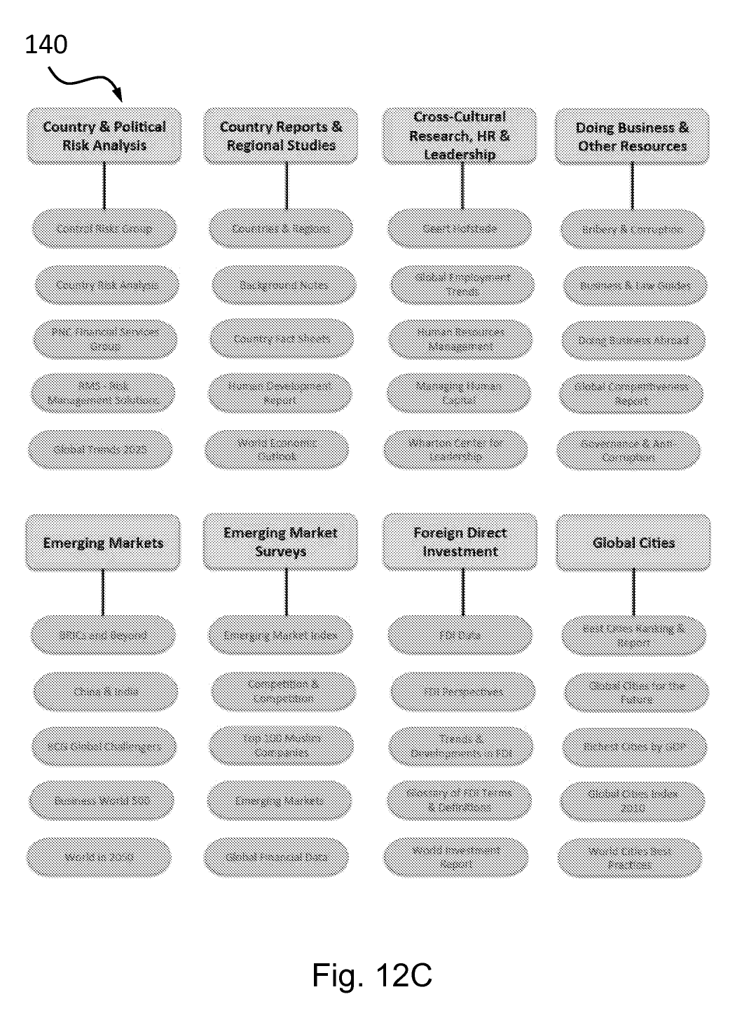

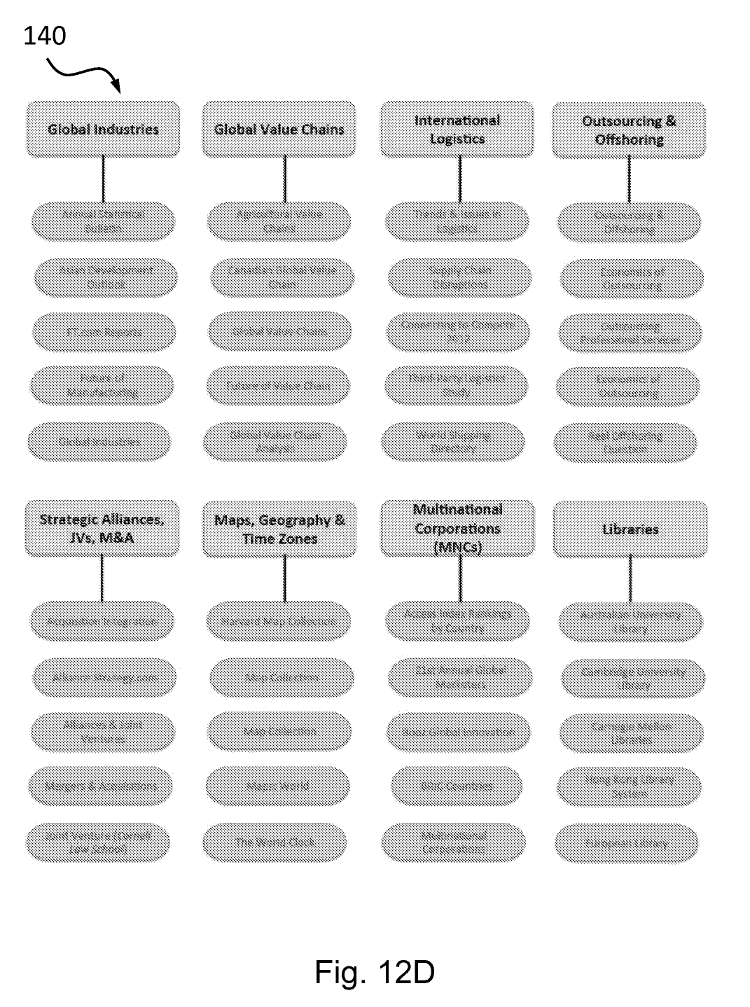

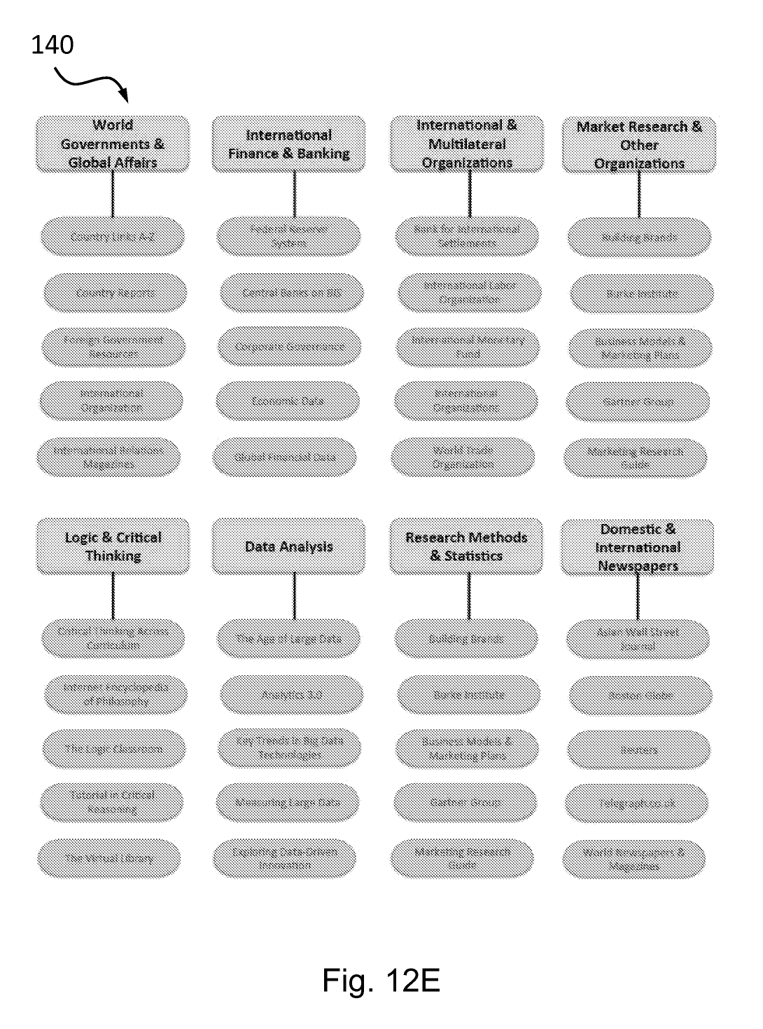

For example, FIGS. 12A through 12J are illustrations of an exemplary list of resources made available via the content selection module 140. As a resource is selected in any of the particular categories, e.g., Academic Journals, the system 10 causes other relevant resources to be highlighted elsewhere in the selections, e.g., Marketing Journals. The association between content is made using metadata, key words, annotations, citations and other threads associated with the relevant course of inquiry. By highlighting the presence of a relevant thread between resources, the researcher, whether student or industrial, is provided with an expedited learning process, avoiding the need for less efficient web searches. Most web search engines rely on presenting titles and topics to a user. The system 10 causes a more intelligent search process to be implemented on behalf of the user to more quickly identify knowledge and resources more on point to the avenue of inquiry.

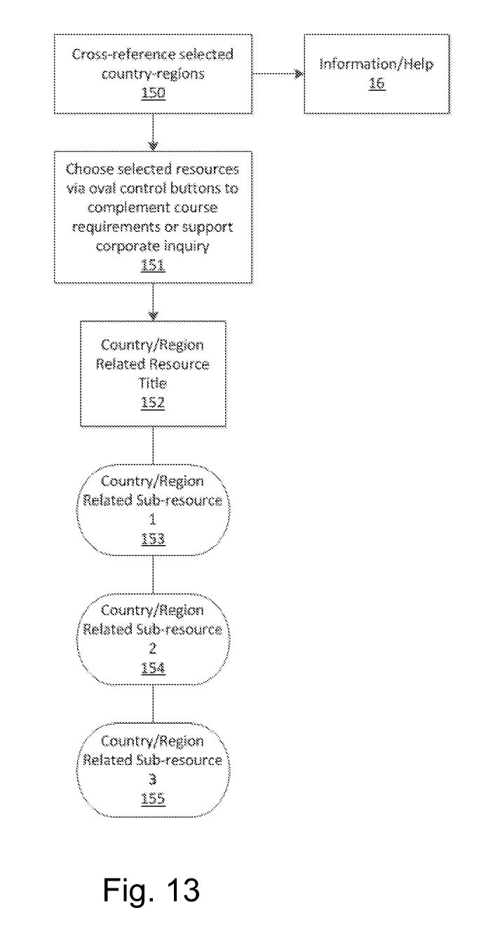

Referring now to FIG. 13, geographic cross reference module 150 supports extrapolation of the inquiry or course of study to selected countries or regions. As a user selects a specific country for further inquiry 151, the system 10 causes country/region related resources 152 complementary to the field of study to be selected and presented to a user for review and consideration. The resources are displayed and grouped, for example, as country/region related sub-resources 153, 154, 155. Students will be able to quickly extrapolate and extend their knowledge base from domestic study to comparisons to other countries around the globe. Corporate users will likewise be able to quickly acquire information relevant to their business and strategic decision-making for other countries. As with the content selection module 140, the geographic cross reference module 150 implements an intelligent association between content and resources, wherein the content and resources are further refined by the selection of the country-region of interest. Again, by using the prior inquiries and research developed by the user and leveraging the selected course syllabus, the system 10 is able to expedite the knowledge acquisition process for the user since a flexible but more directed path has already been configured via the metadata and other indicators triggered by the use of the system 10.

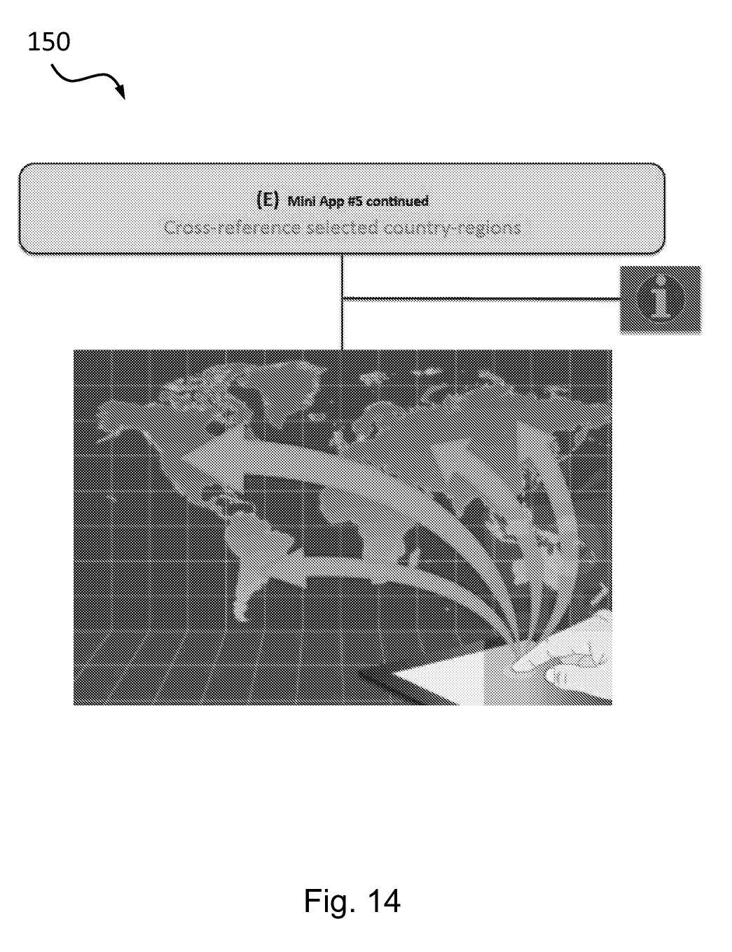

FIG. 14 is an illustration of the touch-centric functionality enabled by the geographic cross-reference module 150 to allow a user to quickly relate a course of study to one or more geographic country-regions. At the touch of the screen at the desired country-region, approximately 200 country/regions are assessable via mostly government approved sites giving full background on population, economic, people-groups, legal and other salient data necessary for a successful completion of a given course or research inquiry from corporate management.

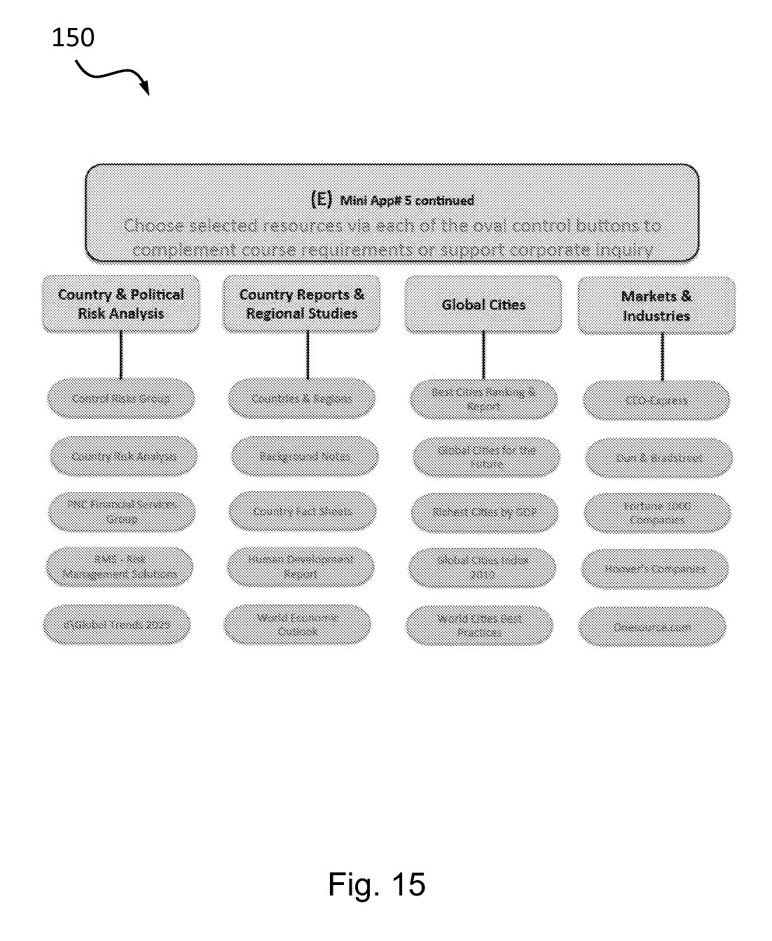

FIG. 15 is an exemplary screenshot of resources enabled by the geographic cross-reference module 150 for selection by a user to support geographic cross-referencing of the particular course of study or inquiry. For example, the user can access resources associated with country and political risk analysis, country reports and regional studies, global cities and markets and industries. Again, metadata produced during the use of the system 10 acts as a trigger to identify potential high-priority associations congruent with the field of study or inquiry.

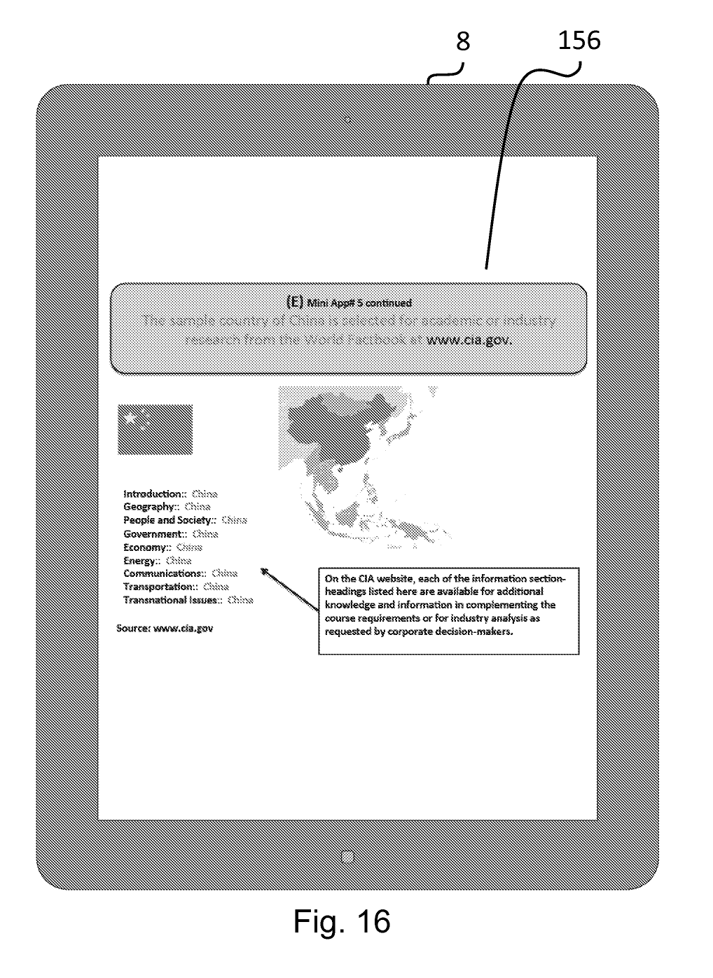

FIG. 16 is an illustrative country cross-reference screenshot 156 on a tablet 8 of information made available to a user via geographic cross-reference module 150 extending a particular course of study or inquiry to a separate country-region. In this case, the user is exploring information relevant to the country of China where specific data has been made accessible by the geographic cross-reference module 150 via a CIA website containing the “WORLD FACTBOOK” maintained and updated by the CIA. The system 10 is configured to intelligently access global resources relevant to the specific inquiry, once again minimizing the amount of inefficient searching required of the user. In addition, where needed, the relevant resource is converted into the user's native language to ease assimilation of the knowledge.

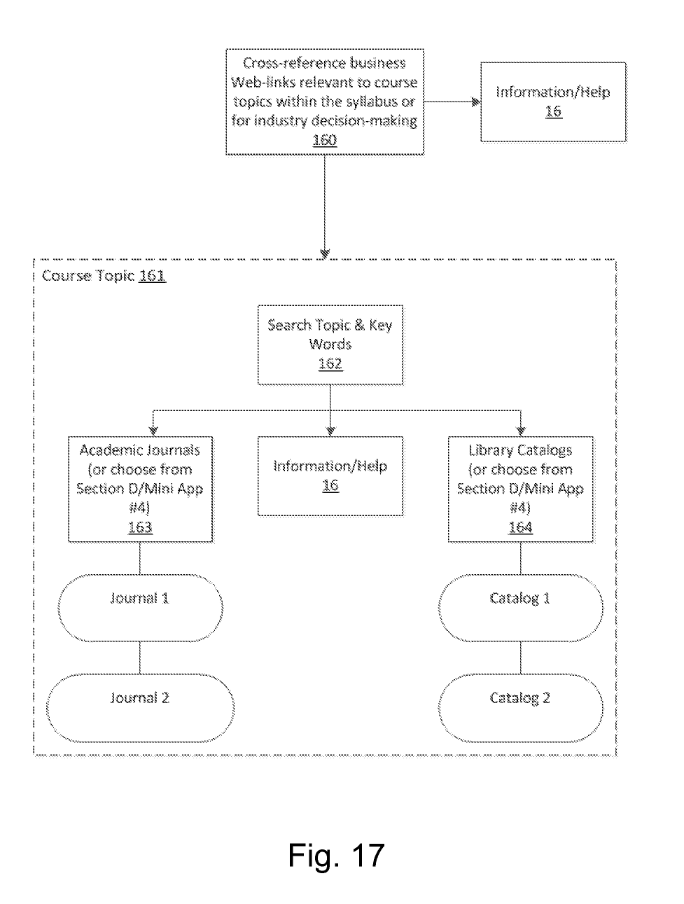

Now referring to FIG. 17, the system 10 supports business link cross-reference (BLCR) module 160 which allows a user to further enhance a course of inquiry. The BLCR module 160, within a particular course topic 161 relevant to the user, provides search functionality 162 so that a user may search for other relevant content based upon topics and key words within his or her course syllabus. The associated intelligent inquiry allows the system 10 to plot a preferred course of action in researching additional appropriate resources within journals 163, on-line libraries 164, and other resources.

Unlike existing web surfing, where one frequently encounters a purportedly good resource only to find out that it cannot be accessed without first registering to obtain access to the content of interest, in one embodiment, the present system 10 provides for access to all relevant content without requiring the user to “buy in” to additional functionality or websites. The system 10 incorporates licensing functionality, which ensures that all content of interest is available without additional charge to a user. Much of the content is made available due to pre-existing integration and incorporation of content from existing government websites. Much of the “paid” research content and articles are frequently available at no charge via government resources. However, the entities charging for the content monopolize the search activity by ensuring that their resource basically swamps the search activity and is presented to a user first, causing the user to have to dig deep to find the equivalent free content. The present system 10 structure content access as “fair use” for educational purposes and subsequently obtains appropriate copyright clearances for access by non-educational users.

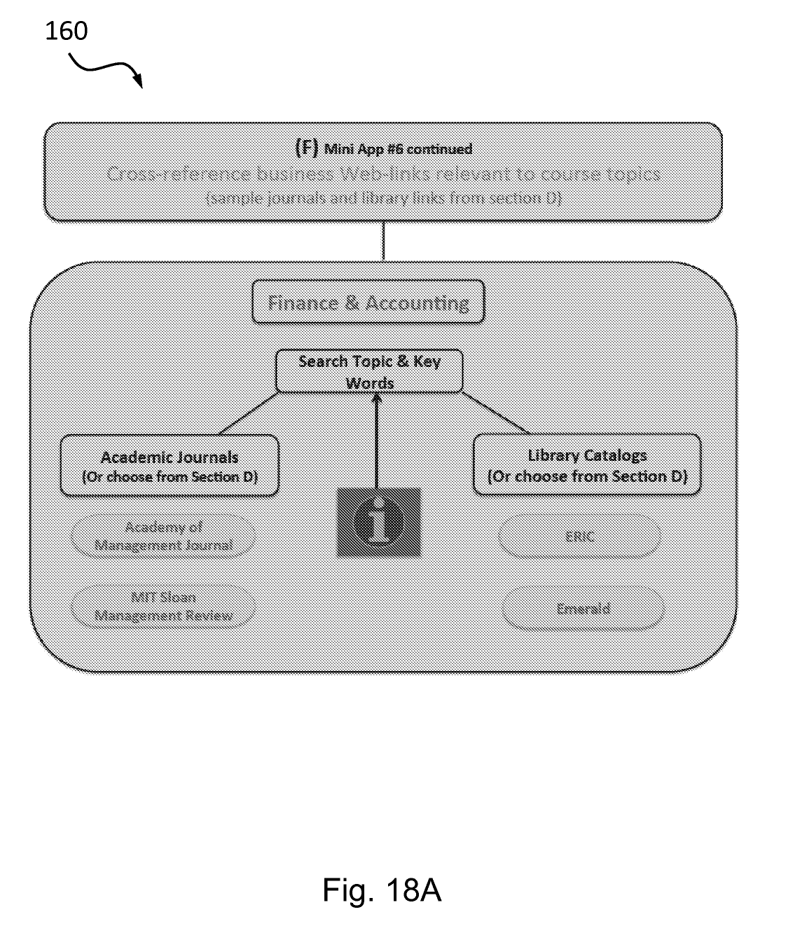

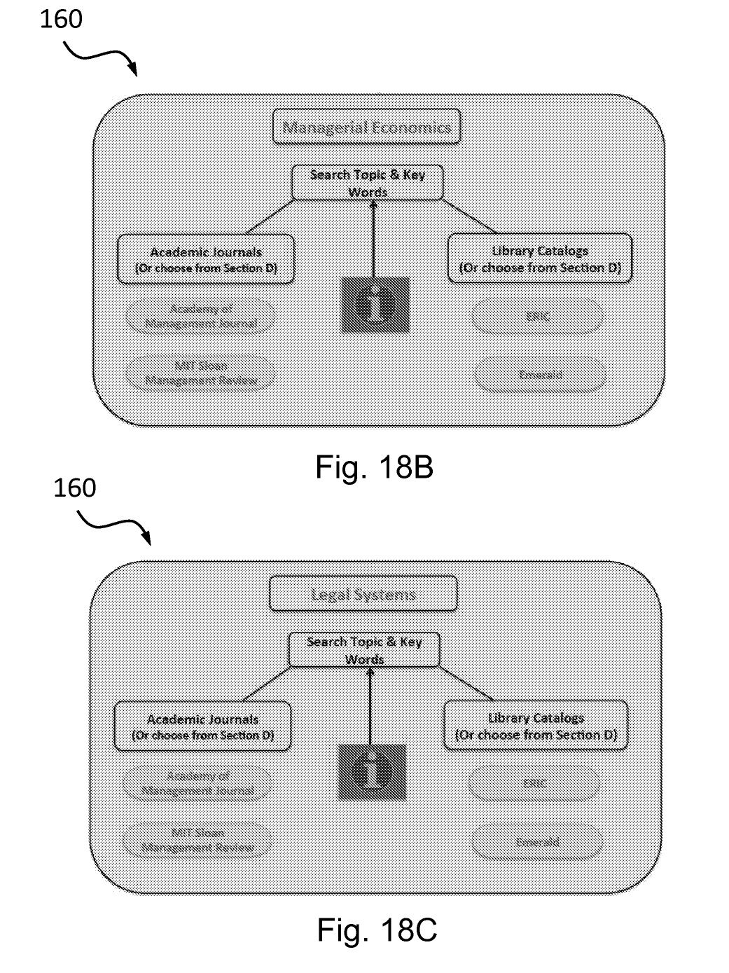

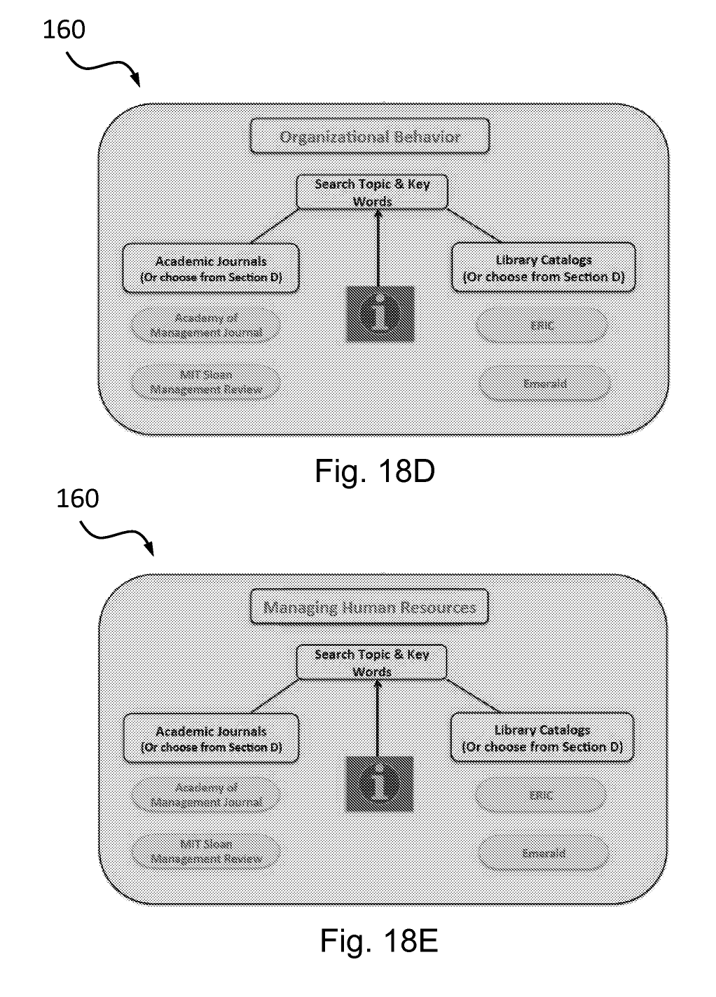

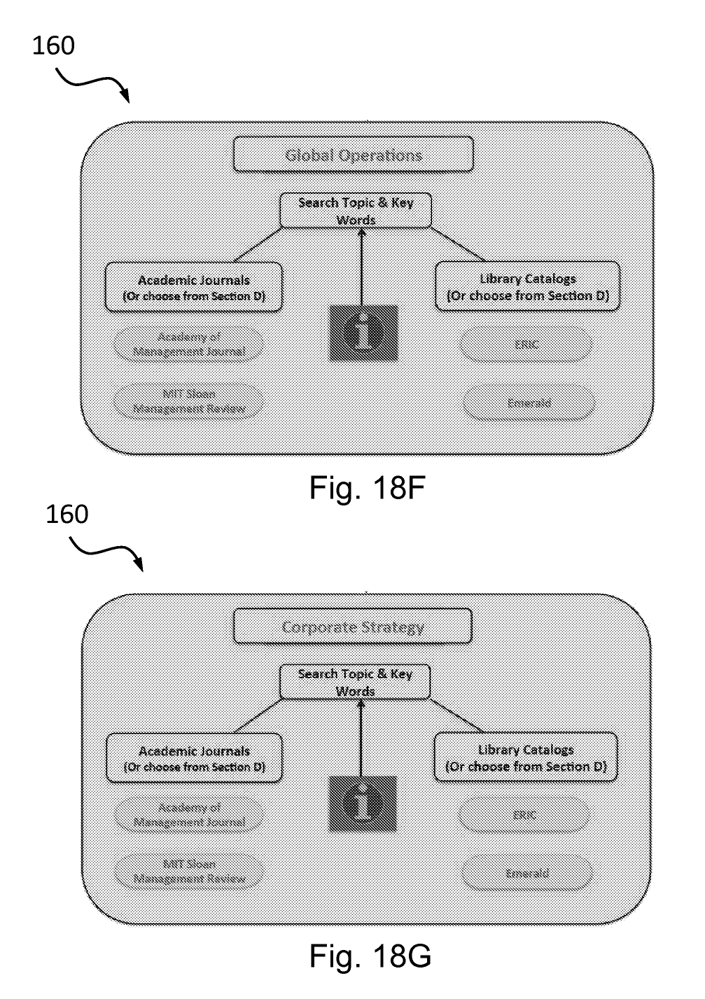

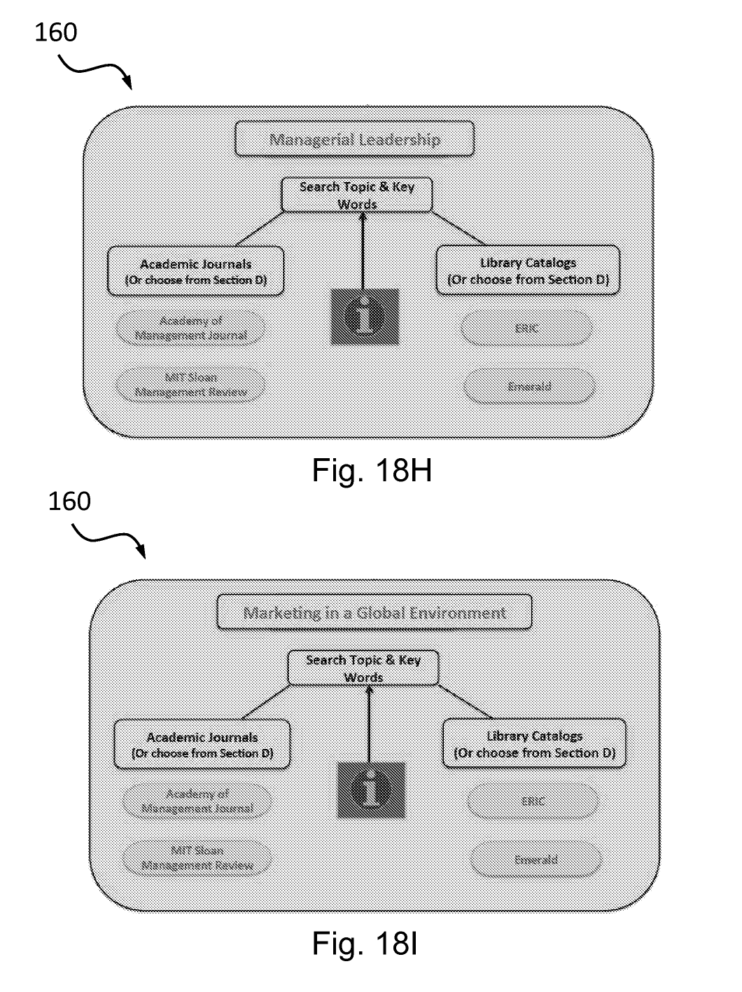

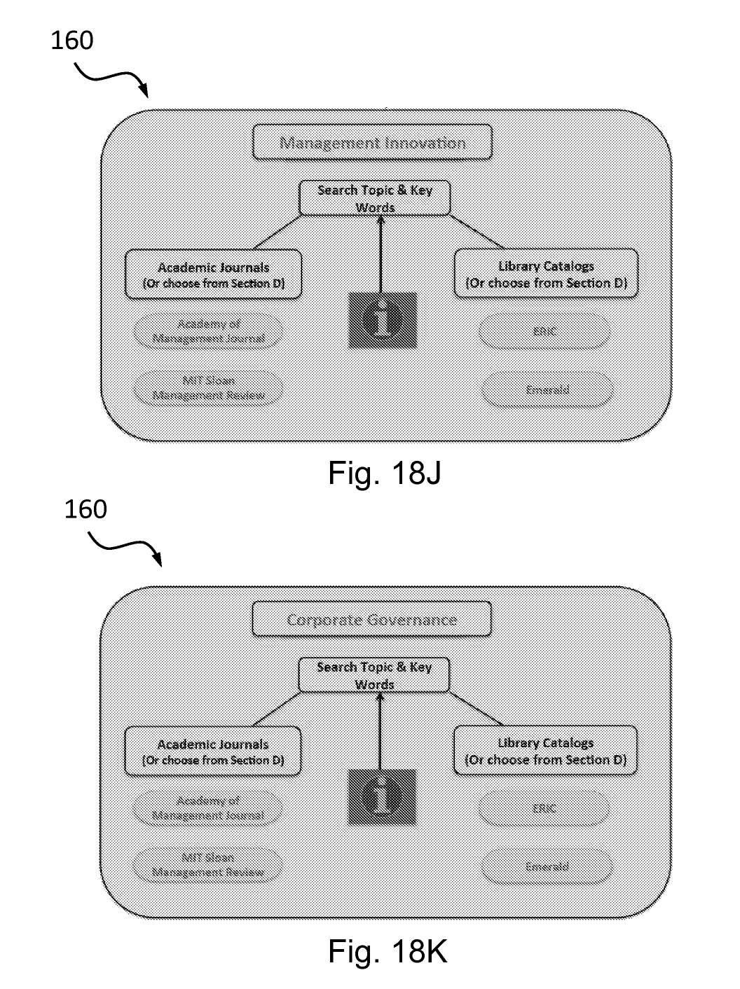

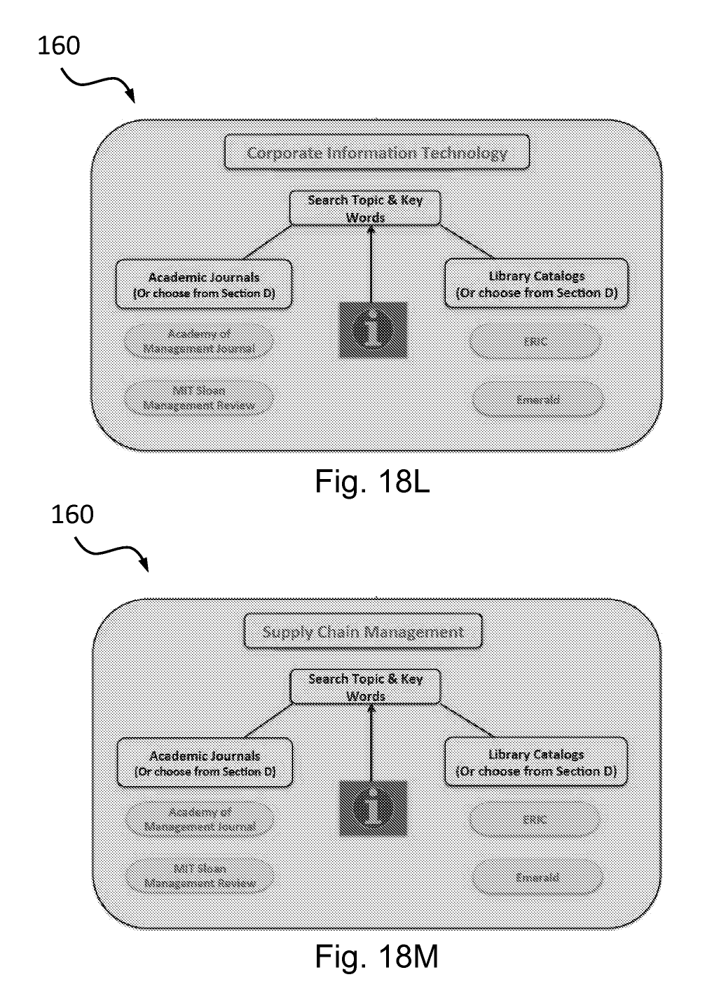

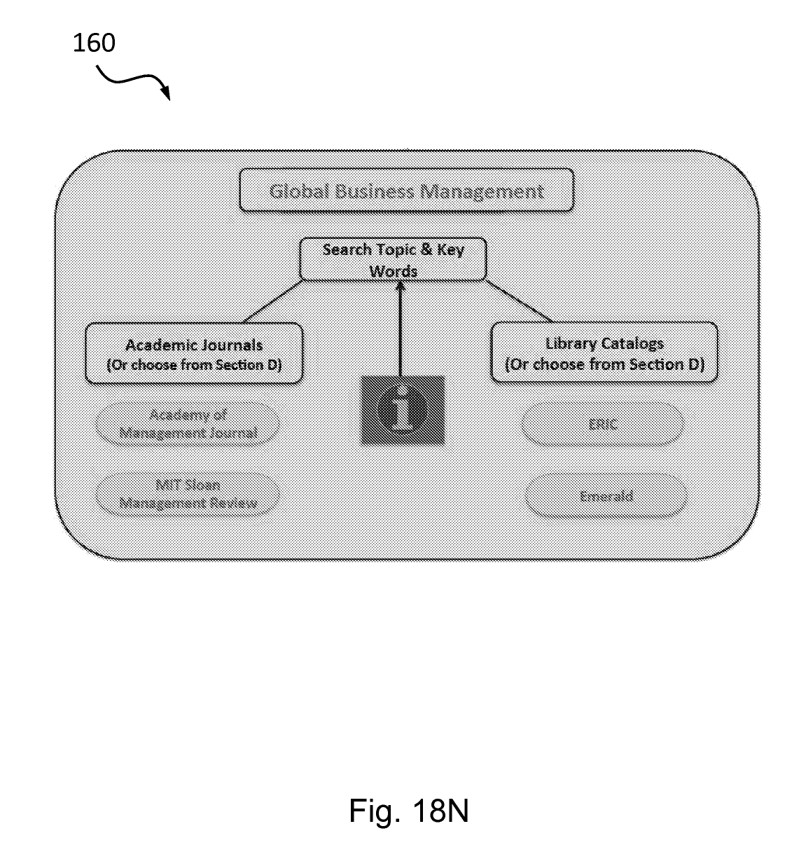

Referring first to FIG. 18A, in the BLCR module 160, a user can click on control buttons associated with a particular journal or other resource and the user will have immediate access to the appropriate links without need for subscription registration, thereby eliminating the need to search the Internet endlessly for additional helpful information. Industry users, such as corporate management, will have a similar experience assessing topics or key words within their respective area of interest, subject to the requirement for specific copyright clearances. It is now well known that a high degree of frustration is encountered when performing research on the Internet and finding that the resource identified by a GOOGLE or other web search takes a user to a paid site with a teaser “blurb” associated with the resource. The user must then decide whether to register with the purveyor of the resource and must take critical time away from the learning or research inquiry.

For academics, students will assess the topics and/or key words within their selected course syllabus to determine the necessary course of action in researching the appropriate resources within the journals and on-line libraries listed. By clicking on the relevant selection, a student will have immediate access to the appropriate links thereby eliminating the potential for inefficient and repetitive endless surfing for possibly inaccurate resources on the Internet.

For industry, corporate management will have the same experience assessing topics and/or key words within their interest in determining the necessary course of action in researching the appropriate resources within the journals and categories. By clicking on the desired selection, the executive/manager will have immediate access to the appropriate links.

FIGS. 18A through 18N provide illustrations of exemplary interfaces associated with system functionality in the BLCR module 160 wherein a user is able to cross reference business web-links relevant to course topics within the selected study syllabus or for industry-specific decision-making. These include, but need not be limited to, topics such as: finance and accounting, managerial economics, legal systems, organizational behavior, global behavior, corporate strategy, managerial leadership, marketing in a global environment, management innovation, corporate governance, corporate information technology, supply chain management, and, global business management. Again, for a field of study or inquiry outside the business focus, the topics available would be changed to adapt to the new field of study.

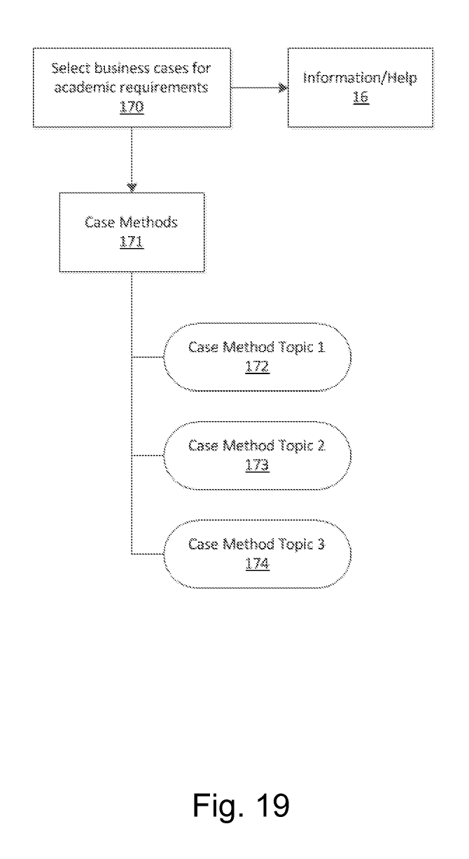

Referring now to FIG. 19, a business case selection (BCS) module 170 provides intelligent access to selected business cases and case methods 171 for further inquiry and investigation. Case studies are invaluable aids in support of academic accomplishments. Industry managers and decision-makers can also acquire valuable knowledge from these academic cases and study mechanisms. Once again, the cases presented to the user will be driven by metadata and other triggers created during the use of the entire system 10 by the student or industrial researcher. Case methods may be grouped for presentation to the user by case method topics 172, 173, 174.

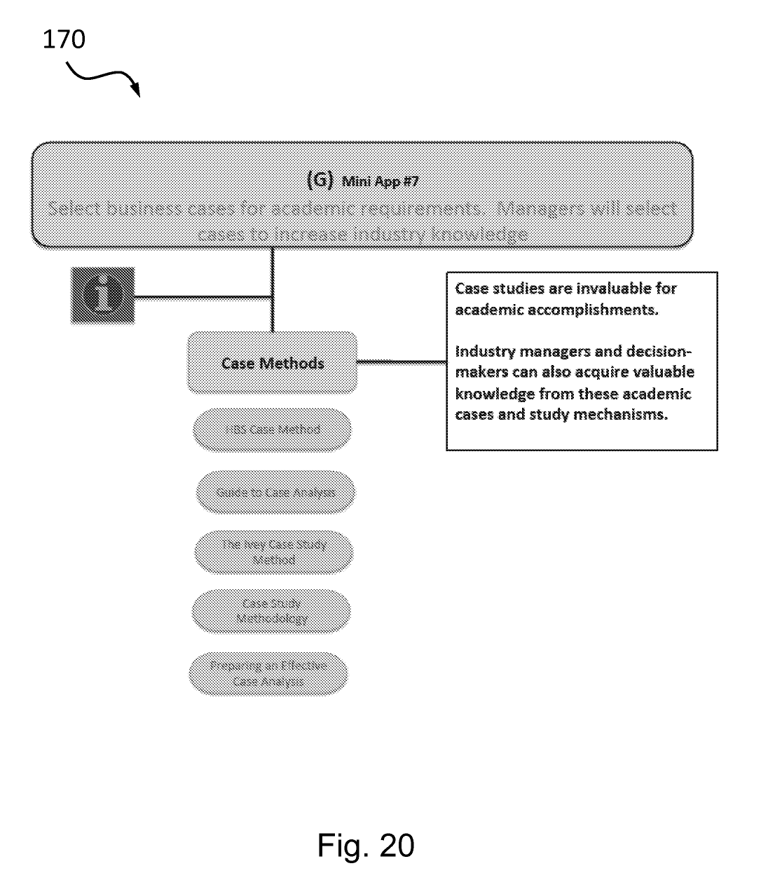

Referring now to FIG. 20, an exemplary screenshot of the functionality of the BCS module 170 described in FIG. 19 is presented. In addition to providing access to relevant cases, the BCS module 170 provides access to resources associated with various case methods along with tutorial information concerning various case study methods.

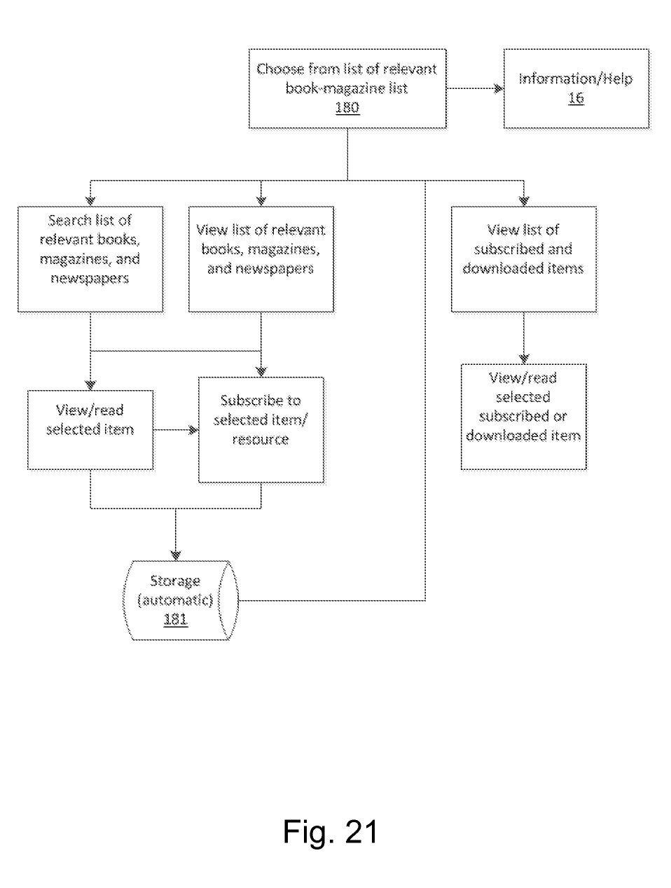

Referring now to FIG. 21, a book-magazine-newspaper module 180, hereinafter the BMN module 180, provides a structure for a user to easily access additional content from books and magazines that is relevant to the course of inquiry. The BMN module 180 also supports management of local or online storage 181 to support prompt access to relevant BMN resources, avoiding the need for repetitive download of each resource. In addition, where subscription for access to a magazine, book, newspaper or other series is required, the BMN module 180 provides for subscription and retention of all information associated with maintenance and renewal of the subscription. The BMN module 180 also advises the user when a current subscription need not be renewed when the course of study or inquiry has changed or evolved over time, thereby avoiding the expense associated with maintenance of unnecessary subscriptions to content.

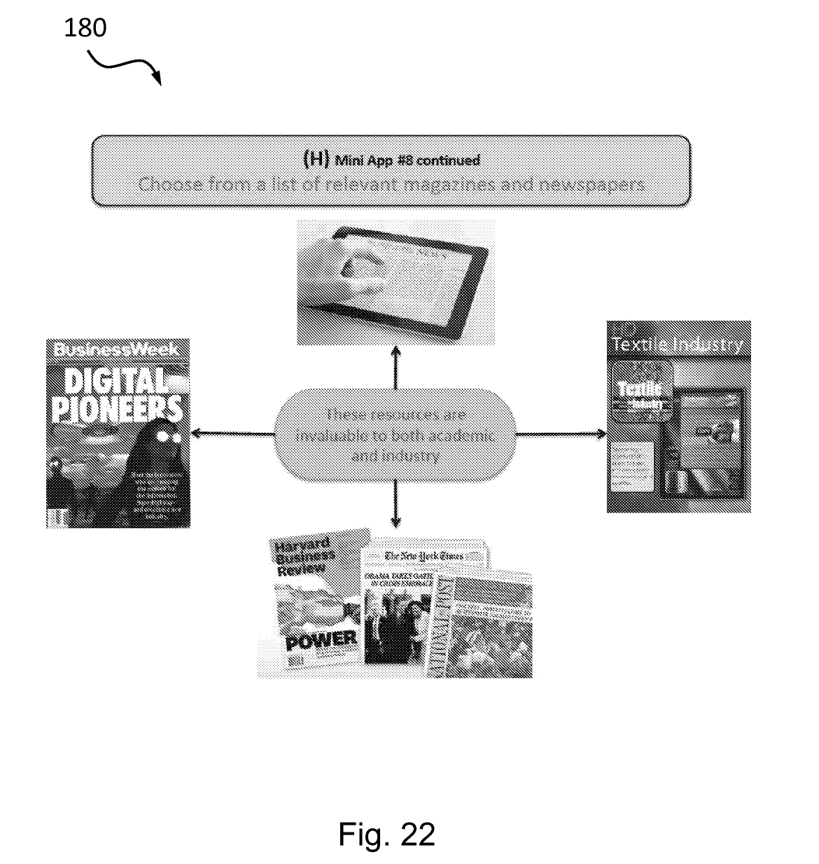

FIG. 22 is an illustrative example of the functionality and types of access associated with the BMN module 180. As with other modules 100 associated with the system 10, the BMN module 180 is an expedited resource for acquiring access to resources invaluable to both academic and industry users.

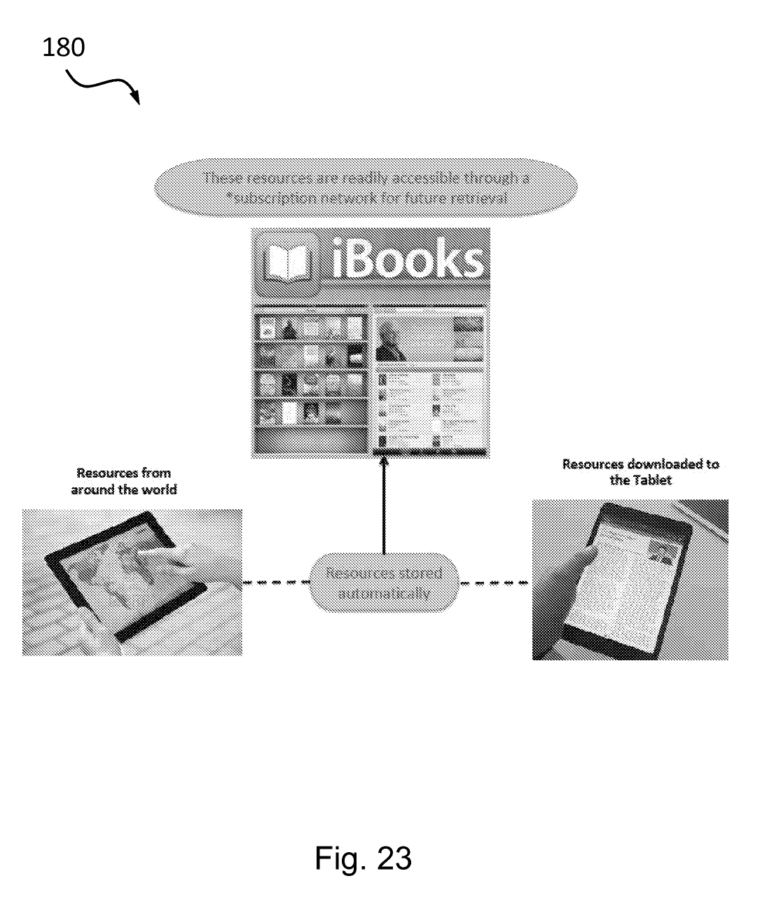

FIG. 23 is a further illustration of the access provided by the system 10 to additional content resources. Although incorporating independent functionality associated with the BMN module 180, the system 10 likewise supports the inclusion of access to existing relevant resources such as the IBOOKS application, the EVERNOTE application, the GOOD READER application and other similar existing eReaders and eContent management solutions. For example, to simplify access, the system 10 automatically uploads selected materials into an eReader application such as iBooks. A user of the system 10 can also manually upload additional found content to a separate eReader as well.

The present invention has been particularly shown and described with respect to certain preferred embodiments and features thereof. However, it should be readily apparent to those of ordinary skill in the art that various changes and modifications in form and detail may be made without departing from the spirit and scope of the inventions as set forth in the appended claims. The inventions illustratively disclosed herein may be practiced without any element which is not specifically disclosed herein.

I claim:

1. A touch-centric learning and research system optimized for use by both academic and industrial audiences comprising:
(a) a software program operable on a touch-centric computing device accessed by a user;
(b) a first module associated with the software program;
(i) the first module providing a choice between a plurality of different course syllabi to the user;
(ii) the first module allowing the user to select a desired course syllabus;
(iii) the first module providing the user with access to activities and resources associated with the desired course syllabus selected by the user;
(c) a second module associated with the software program;
(i) the second module causing the system to present an exemplary list of relevant industries, said exemplary list of relevant industries being naturally associated with a selected curriculum of study;
(ii) the second module allowing the user to select a desired industry from the exemplary list of relevant industries;
(iii) the second module causing information and resources associated with a selected industry to be prioritized for presentation to the user in keeping with the desired course syllabus selected by the user;
(d) a third module associated with the software program;
(i) the third module allowing the user to access relevant audio discussions from one or more professors and corporate executives around the world;
(ii) the third module allowing the user to select a professor or other representation to access a desired discussion, whereupon the third module causes audio to be played to the user;
(iii) the third module allowing the user to convert the audio to a desired language for playback via a translation function;
(iv) the third module providing a translation of the relevant audio discussions to a desired language of the user, said translation presented in either an audio format or a visual subtext;
(e) a fourth module associated with the software program;
(i) the fourth module providing a list of relevant resources to the user for selection and retrieval;
(ii) the fourth module determining relevancy each of said relevant resources using metadata, key words, annotations, citations, and other threads associated with a course of inquiry;
(f) a fifth module associated with the software program;
(i) the fifth module causing country and region related resources complementary to a field of study to be selected and presented to the user for review;
(ii) the fifth module causing the country and region related resources to be further refined by a selection of the country-region of interest;
(iii) the fifth module causing the country and region related resources to be intelligently refined by the user's prior inquiries and research in the system and by the desired course syllabus selected by the user;
(g) a sixth module associated with the software program;
(i) the sixth module providing search functionality so that the user may search for other relevant content based upon topics and key words within the desired course syllabus selected by the user;
(ii) the sixth module allowing the system to plot a preferred course of action in researching additional appropriate resources within journals, on-line libraries, and other resources;
(h) a seventh module associated with the software program, the seventh module providing the user with intelligent access to selected business cases and case methods, said access driven by metadata and other triggers created during the user's use of the system;
(i) an eighth module associated with the software program;
(i) the eighth module providing a structure for the user to easily access additional content from books and magazines relevant to the course of inquiry;
(ii) the eighth module managing local and online storage to support prompt access to relevant resources and preventing repetitive download of each resource;
(iii) the eighth module providing for subscription and retention of all information associated with maintenance and renewal of resource subscriptions, where subscription for access to a magazine, book, newspaper or other series is required; and
(iv) the eighth module advising the user when a current subscription need not be renewed when the course of study has changed or evolved over time.

2. The touch-centric learning and research system of claim 1, wherein the software program is restricted to operation on touch input devices to ensure that the user relies solely on touch-centric input interface and therefore learns to optimally use the system, which has been designed to optimally leverage the capability of touch input.

3. The touch-centric learning and research system of claim 1, wherein the system serves dual use as both an instrument for academic instruction and learning as well as a tool for industrial research and investigation.

4. The touch-centric learning and research system of claim 1, wherein the desired course syllabus is configured to support present and additional levels of educational matriculation, including completion of degrees in business at the bachelor, masters, doctoral, and post-doctoral levels.

5. The touch-centric learning and research system of claim 1, wherein the selected curriculum of study is determined from the desired course syllabus.

6. The touch-centric learning and research system of claim 1, wherein the relevant resources includes real-time access to a professor, instructor, or subject matter expert.

7. The touch-centric learning and research system of claim 1, wherein the course of inquiry is determined from the desired course syllabus.

8. The touch-centric learning and research system of claim 1, wherein the sixth module incorporates licensing functionality by pre-existing integration and incorporation of content from existing government and private websites and resources, which ensures that all content of interest is available without additional payment or steps by the user and avoids content requiring registration or payment.

9. A touch-operable academic and business industry learning system comprising modules providing functionality for a user to:
(a) choose an appropriate course syllabi and teaching material;
(b) select a particular industry of interest;
(c) access audio discussions from selected experts worldwide on a selected topic;
(d) access a plurality of relevant resources including professors, instructors, subject matter experts and business, marketing, and statistical articles that complement academic course requirements or support a targeted corporate inquiry;
(e) cross-reference selected content to other countries and regions;
(f) cross-reference to various other web-based resources relevant to course topics or on-point with the corporate inquiry and with decision-making requirements;
(g) access and select relevant business cases deemed supportive of academic and industrial inquiries; and
(h) obtain immediate access to relevant e-Books, magazines, and newspapers consistent with or complementary to a course of study or evolving shape of an industrial inquiry.

10. The touch-operable academic and business industry learning system of claim 9, wherein the system is restricted to application on touch input devices to ensure that the user relies solely on a touch-centric input interface and therefore learns to optimally use the system, which has been designed to optimally leverage the capability of touch input.

11. The touch-operable academic and business industry learning system of claim 9, wherein the system serves as a portal for access to a plurality of integrated resources, including professors, instructors, subject matter experts, academic journals, eBooks, magazines, newspapers, business web-links, business cases, global countries, industry resources, and related audio lectures.

12. The touch-operable academic and business industry learning system of claim 9, wherein each module is intelligently connected with content or metadata in one or more of the modules, and selection of a particular module and of content within the particular module triggers expectations within one or more of the modules for provision of additional relevant content to the user.

13. The touch-operable academic and business industry learning system of claim 9, wherein the system provides an optimized experience for delivery of appropriate curricula and educational and research resources to industry stakeholders, including:
(a) CXOs, including executives, operating, financial, and technology officers;
(b) general managers
(c) directors of marketing, accounting, human resources, information technology; and
(d) managers of production, operations, quality control, environmental and business development.

14. The touch-operable academic and business industry learning system of claim 9, wherein said plurality of relevant resources is highlighted and associated for the user using metadata, key words, annotations, citations and other threads associated with an inquiry, providing the user with an expedited learning process and avoiding the need for external web searches.

15. The touch-operable academic and business industry learning system of claim 9, wherein an interface is directed towards and limited to education and knowledge gathering for financial, economic and business matters.

16. A touch-centric learning system comprising:
(a) a touch-centric computing device; and
(b) one or more software modules configured to run on the touch-centric computing device, the one or more software models integrated to support matriculation at multiple degree levels within a selected field of education.

17. The touch-centric learning system of claim 16, further including a plurality of resources associated with the selected field of education wherein the plurality of resources are accessed via a touch interface.

18. The touch-centric learning system of claim 16, the system further comprising a plurality of digital resource repositories structured and assembled to automatically provide expedited and intelligent access to and between the various resources in each of the repositories consistent with a user's selected field of study.

19. The touch-centric learning system of claim 16, wherein each touch-centric computing device serves as a portal for access to a plurality of integrated resources, including academic journals, eBooks, magazines, newspapers, business web-links, business cases, global countries, industry resources, and related audio lectures.

20. The touch-centric learning system of claim 16, wherein the system provides an optimized experience for delivery of appropriate curricula and educational and research resources to a plurality of different industry stakeholders.
